(19) United States
(12) Patent Application Publication
(10) Pub. No.: US 2002/0059272 A1
(43) Pub. Date: May 16, 2002

(54) Apparatuses, methods, programming, and propagated signals for creating, editing, organizing and viewing collaborative databases

(76) Inventor: Edward W. Porter, Boston, MA (US)

Correspondence Address: Edward W. Porter, Porter & Associates, Suite 600, One Broadway, Cambridge, MA, 02142, US

(21) Appl. No.: 09/839,987

(22) Filed: Apr. 20, 2001

Related U.S. Application Data
(60) Provisional application No. 60/198,694, filed on Apr. 20, 2000.

(51) Int. Cl. G06F 7/00

(52) U.S. Cl. 707/100

(57) ABSTRACT

A computerized method of collaboratively ordering information comprises: storing a plurality of information nodes; enabling a user to give an ordinal rank to a nodes under a parent node; ranking nodes under their parent node as a function of the ordinal ranking given to them by each of a group of users; and displaying nodes under their parent ordered by such rankings. The nodes can be statements about a subject, articles, multimedia presentations, suggestions about other nodes, discussion threads, URLs, advertisements, etc. In some embodiments a user can select to see nodes ordered by the rankings given them by different sets of users. In some embodiments, nodes can be ranked under a parent node, and parent nodes can be ranked under other parent nodes. In some embodiments the same node can have different rankings under different parent nodes. In some hierarchical embodiments a user can view the hierarchy of nodes with select parent nodes having their child nodes displayed. In some embodiments a user can alternatively select to view nodes ordered by other criteria including: date of creation; number of non-ordinal votes received, amount or type of user activity association with node, and amount or type of change associated with the node in a given time. In some embodiments, desired nodes are made easier to find with searching tools and/or indexing. Some embodiments provide tools for collaboratively editing nodes or verifying their contents. In some embodiments the method is practiced on line, such as in a client-server environment.

### RELATED APPLICATIONS

This application is a continuation-in-part of and claims priority under 35 U.S.C. .§119(e) of the co-pending U.S. provisional application Ser. No. 60/198694 filed by Edward W. Porter on Apr. 20, 2001 and entitled “Apparatuses, Methods, Programming, And Propagated Signals For Creating Editing, Oranizing and Viewing Collaborative Databases” (hereinafter “The Provisional Application”) The Provisional Application is also hereby incorporated by reference.

### FIELD OF THE INVENTION

The present invention relates to apparatuses, methods, programming, and propagated signals for creating, editing, organizing and viewing collaborative databases.

### BACKGROUND OF THE INVENTION

Collaborative databases have been around in different forms for many years. For example, back in the days when host-terminal networks were common, it was routine for multiple users to enter data into, or view data from, a common database. Such a database was a form of collaborative database. A more free form of collaborative database existed on many prior art bulletin boards. These were systems which allowed users, who traditionally connected to a host computer through a dial-up connection, to enter information into, or view data from, a database stored on the host computer, including chat and threaded chat.

As many computer users will know, chat is provided on a network system when two or more users can exchange messages in a commonly viewable forum. Threaded chat is similar, except that allows a user to address an individual message as a response to a previous message. Traditionally, threaded chat is viewed hierarchically with each message that is a response to another message being shown indented underneath it.

Another form of collaborative database that is gaining prominence more recently is the open directory movement, which is a system for enabling volunteers to rank Web sites or Web pages under various directory headings.

Another form of prior art collaborative database creation, is represented in collaborative editing programs, which allow one user to create a text, and allow others to view, comments, and suggest editorial changes to that text.

### SUMMARY OF THE INVENTION

The present invention relates to apparatuses, methods, programming, and propagated signals for creating, editing, organizing and viewing collaborative databases of the type described in this specification and the claims below. The claims below summarize the invention fairly briefly, particularly the independent claims. The definitions of the invention contained in the claims are not intended to be limited to the particular embodiments shown in the invention, unless, and to the extent, that their working indicates otherwise.

The definitions of the invention contained in these claims are based on the doctrine of claim differentiation. Thus, in any hierarchy of claims in which a given dependent claim contains a given limitation not included in one or more parent claims from which the given claim depends, the invention recited in the parent claims should be understood as not requiring inclusion of the given limitation.

It should also be understood that the claims contained in this provisional application do not recite all of the aspects of the invention disclosed in the specification which the inventor believes may be patentable. In particular, the inventions is also intended to include apparatus for performing the methods recited in the claims, computer programming recorded on machine readable memory having instructions for performing such method, propagated signal claims reciting the signals necessary for performing what could be the client side of such methods, and propagated signal claims recited the signals necessary for performing what could be the server side of such methods.

### DESCRIPTION OF THE DRAWINGS

These and other aspects of the present invention will become more evident upon reading the following description of the preferred embodiment in conjunction with the accompanying drawings.

FIG. 1 is a schematic illustration of a networked system providing an embodiment of the present invention;

FIG. 2 is a schematic illustration of an alternative network system providing an embodiment of the present invention;

FIG. 3 is a graphical illustration of a node hierarchy of a type that can be ordered according to aspects of the present invention;

FIG. 4 is a schematic illustration of a nodeList data structure for use in organizing data nodes of the type shown in FIG. 3;

FIG. 5 is a schematic illustration of a userActionList data structure for storing data about actions that individual users have taken with regard to nodes of the type shown in FIG. 3;

FIG. 6 is a schematic illustration of a userList data structure for storing information about individual users of an embodiment of the present invention;

FIG. 7 is a schematic illustration of how a user is enabled to rank nodes of the general type shown in FIG. 3 by means of a drag-and-drop interface in some embodiments of the present invention;

FIGS. 8 and 9 illustrates how user can rank nodes with a browser having more primitive capabilities than those that would be required for the interface shown in FIG. 7;

FIG. 10 illustrates different rankings provided to nodes under a given parent heading by five different users using the interface shown in FIGS. 8 and 9;

FIG. 11 illustrates how a collective ranking for these headings is calculated for a user group consisting of all five of the user shown in FIG. 10;

FIG. 12 illustrates how the collective ranking calculated in FIG. 11 would be displayed in an interface of the type shown in FIGS. 8 and 9;

FIG. 13 illustrates how a collective ranking is calculated for a user group consisting of two of the users shown in FIG. 10;

FIG. 14 illustrates how the collective ranking calculated in FIG. 13 would be displayed in an interface of the type shown in FIGS. 8 and 9;

FIGS. 15 through 17 illustrates how a user can copy and paste a node from under one parent nodes in a outline such as that shown in FIG. 3 to a ranked location under another parent node in that hierarchy of nodes;

FIG. 18 illustrates a portion of a page view generated about portion of a database of nodes designed for discussion of political and social issues;

FIG. 19 represents the controls of a node control window that is displayed if a user clicks on one of the node control shown in front of each node in FIG. 18;

FIGS. 20 through 22 represent views of the database shown in FIG. 18 with individual nodes expanded to different levels;

FIG. 23 provides a high-level pseudo code description of the process of generating a view of a portion of a hierarchical database according to an embodiment of the present invention;

FIG. 24 represents the controls of a viewControl window that enable a user to control the display of a portion of a hierarchical database;

FIG. 25 represents a view of an individual statement node with its text body fully expanded;

FIG. 26 represents the controls in a defineNewGroup window, which enables a user to define a selected group of the systems users, which, once defined, can be used for various purposes in the system;

FIG. 27 represents a view of voteGroup window, which allows a user to see which of the system's users have taken a certain position on a given vote;

FIGS. 28 through 32 define the structure of the home, heading, actionList, statement, and vote node types, which are types of nodes used in one embodiment of the invention designed for discussion of political and social issues;

Face 33 through 36 each represent a view of individual nodes and their associated vote lists, indicating the different types of votes which can be associated with such nodes and the different ways such votes can be displayed;

FIGS. 37 through 43 define the structure of chatForum, chatThreadStart, chatResponse, pro, con, and the banner node types, which are all node types used in one embodiment of the invention designed for discussion of political and social issues;

FIG. 44 represents a view of a portion of a database designed for social and political discussion that is dedicated to enabling users to purchase banner advertisements;

FIGS. 45A and 45B illustrates a top-level hierarchical command menu that is provided in one embodiments of the invention;

FIG. 46 illustrates steps taken if the user selects the cut option shown under the Edit menu of FIG. 45A;

FIG. 47 illustrates steps taken if the user selects the copy option shown under the Edit menu of FIG. 45A;

FIG. 48 illustrates steps taken if the user selects the paste option shown under the Edit menu of FIG. 45A;

Step 49 illustrates steps taken if the user selects the pasteAsLink option shown under the Edit menu of FIG. 45A;

FIG. 50 illustrates steps taken if the user selects the internalSelection option shown under the Edit menu of FIG. 45A;

FIG. 51 illustrates steps taken if the user selects the newNode option shown under the Edit menu of FIG. 45A;

FIG. 52 illustrates steps taken if the user selects the createCitationsNerification option shown under the Edit menu of FIG. 45A;

FIG. 53 defines the structure of a verification node type, the type of node created by the steps of FIG. 52;

FIG. 54 represents a view of a verification node of the type created by the steps of FIG. 52;

FIG. 55 illustrates step taken if the user selects the internalComments option under the View menu of FIG. 45;

FIG. 56 represents a view which has two windows, a text view window in which a user can see one or more nodes of the outline with their text containing comment icons which illustrates locations in that text which users have placed comments, and a second commentList window in which a user can see the comments which have been associated with a selected one of the comment icons shown in the text view window;

FIG. 57 defines the structure of an internalComment node type, which is a node of type associated with each of the comment icons shown in FIG. 56;

FIG. 58 illustrates steps taken if a user selects the internalselection option under the Edit menu of FIG. 45A;

FIG. 59 illustrates steps taken if the user selects the collaborativeEdit option shown under the Edit menu of FIG. 45A;

FIGS. 60 through 62 represent views generated for performing collaborative editing by the steps of FIG. 59;

FIGS. 63 through 67, respectively, define the structure of the favorites, users, user, groups, and group node types which are used in the embodiment of the invention having the menu shown in FIGS. 45A and 45B;

FIG. 68 illustrates steps performed if the user selects the index option under the GoTo menu of FIG. 45B;

FIG. 69 represents a view generated by the steps of FIG. 68;

FIGS. 70 through 72 define the structure of index, indexHeading, and indexEntry node types, which are each a type of node used in the view shown in FIG. 69;

FIG. 73 illustrates steps performed if a user selects the mail option shown under the GoTo menu of FIG. 45B;

FIG. 74 shows steps performed if the user selects the search option in the top level of the menu of FIG. 45B;

FIG. 75 shows the steps performed if a user selects the certifyPageCopy option under the webpage menu of FIG. 45B;

FIG. 76 shows steps performed if the user selects the checkCertifiedPageCopy option under the webPage menu shown in FIG. 45B; and

FIG. 77 shows steps performed if the user selects the verifiedWebQuoted option under the webPage menu of FIG. 45B.

### DETAILED DESCRIPTION OF PREFERRED EMBODIMENTS

The present invention relates to apparatuses, methods and programming for creating, editing, and view collaborative database.

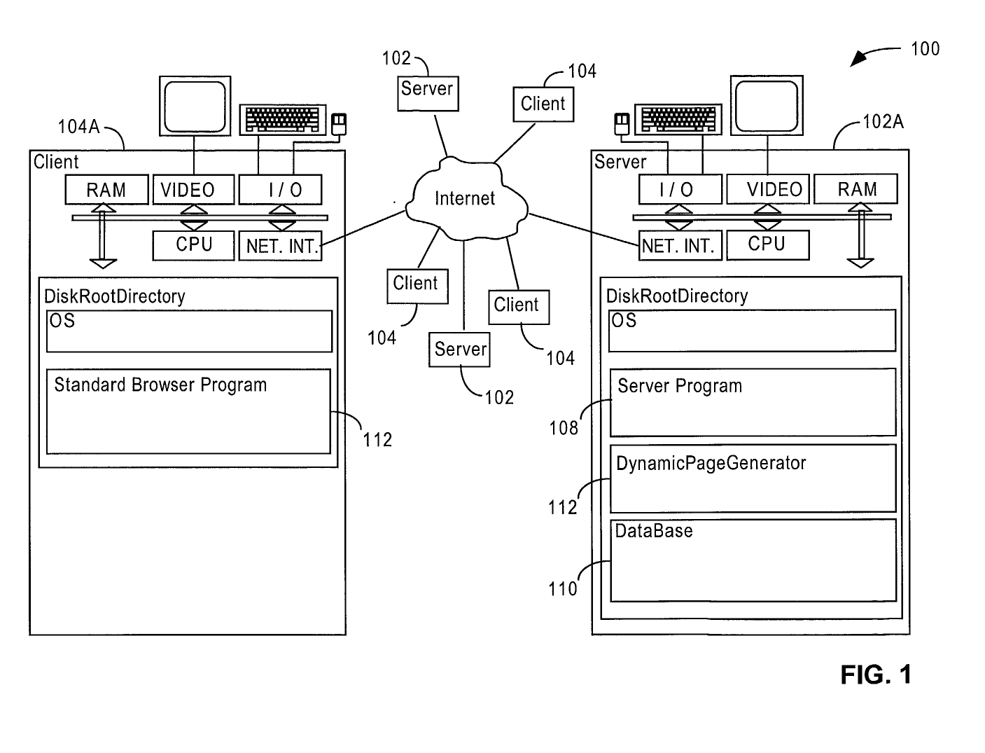

FIG. 1 illustrates one possible embodiment 100 of the invention. The system 100 is a network system comprised of the server computer 102A and one or more client computers 104. In the preferred embodiment the system 100 is designed to operate on the Internet 106 and uses the World Wide Web. In other embodiments of the invention other types of computer networks could be used besides the Internet. In the preferred embodiment the server 102A can be virtually any type of server table of acting as the server on the World Wide Web. Similarly the client's 104 can be virtually any type of computer cable of functioning as a Web browsing client on the World Wide Web.

Preferably the server computer 102 includes both a server program 108 table of responding to HTTP requests and a database 100 in which collaboratively created in the edited information can be stored. Also the system 102 a includes dynamic page generating software 112, preferably in the form of scripts, such a CGI scripts, which are cable of responding to HTTP requests by dynamically generating Web pages in response to such requests.

The client 104a in many preferred embodiments will include a standard browser program 112 cable of generating HTTP requests to the server 102a.

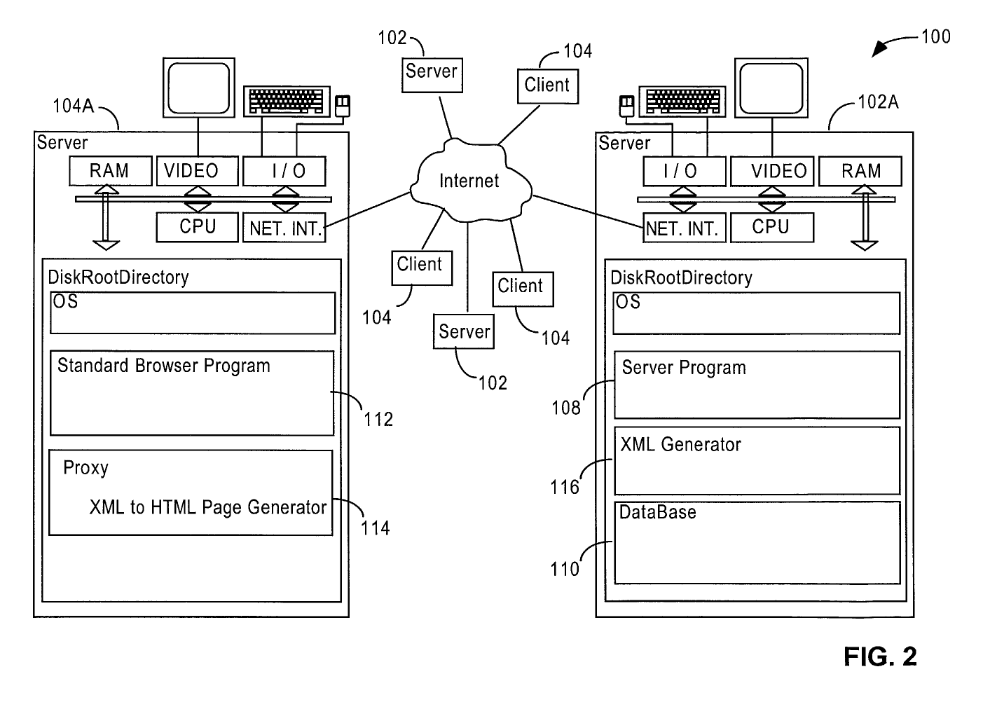

It is intended to the present invention cover aspects of couldn't collaborative computing which are not only applicable to what are currently, and standard browser programs, but too many other possible browsing capabilities which could be made available width present technology, and which will be available in the future within several years. Thus, the user interface to be used with a particular embodiment of the invention can vary considerably as a function of the capability of the browser that exists on the client computer toward which an embodiment of the invention is targeted. In fact, will probably be common to many embodiments of the invention will be designed to provide different interfaces to browser's having different levels of capability. Also is the case that the user interface, and the distribution of functionality between the server and client will vary as a function of the latency and bandwidth that exists between the server and the client. Some embodiments of the invention may assume that the browser 112 has little capability, except that abusing standard HTML in conjunction with use of forms and CGI scripts. In other embodiments of, or interfaces provided by, the invention it might be assumed that the browser can execute JavaScript or jab a code. Yet other embodiments of the invention might be designed assuming that either the browser program, or a proxy for it, such as shown in FIG. 2, is capable of performing considerably more functions, then can standard browser programs. For example as is in shown in FIG. 2, in one embodiments of the invention the server 102 a might use a program 116 which functions as I dynamic page generator to download XML pages representing content in the database 110 to the server computer 104. The server computer 104 can have a proxy 114 that converts that XML text to an HTML page, which will then be transferred to a standard browser 112 within the client, so as to be shown as a standard web page. This would allow some of the functionality which is intended for many aspects of the present invention, such as generating many different use of complex data structures, to be performed upon the server 104a, rather than requiring all such pages to be generated on the server. In other embodiments of the invention, complex jab a program's, or other types of downloadable Web programs, could be sent to the server computer 104 to provide a fast interactive user interface providing much more speed and eat, then would be available with a standard HTML, or even a collection of small JavaScript, or jab a, functions.

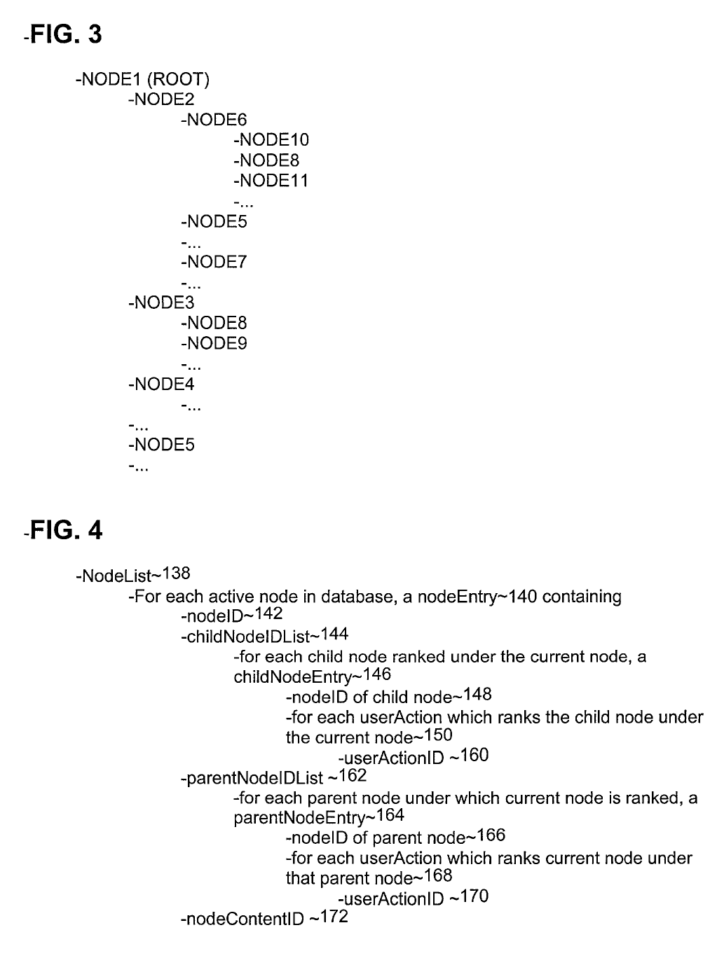

Referring to FIG. 3, in the preferred embodiment of the invention information is represented in a hierarchical list of information nodes such as is shown in FIG. 3. These nodes can be comprised of virtually any type of information, including text, graphics, audio, video, or a combination of any such medias.

FIG. 3 shows a plurality of nodes, node2 through note11, shown as being organized under a root node labels node1. In the preferred embodiment of the invention a given node can be placed under multiple headings. For example, in FIG. 3 node5 is placed both under node1 and node2. Similarly, node8 is shown as occurring directly under node3 and node6. This is allowed, because in a collaborative environment in which the invention is intended to be used, different users may considered it appropriate to place a given node under different headings. In addition, even a single user may feel that a given node should be placed under multiple different parent nodes.

According to some aspects of the invention, not only can multiple people collaboratively decide under which nodes of a hierarchical outline a given node should be placed, but that it also what ranked under any individual parent node a given node should be placed. Such collaborative ranking can be performed in many different ways. To list to just a few, it can be based on the number of people the vote for or against a given node, it can be based on the amount of users who interacted with a given node a given period of time, or it can be based on the number of users who consider a given node to be the most important node under its parent node. According to some aspects of the invention, the ranking of child nodes under given parent node is performed by enabling each user to ordinally rank one or more child nodes under a parent node, and then combining the ordinal rankings from multiple users to compute a collaborative ordinal ranking for child nodes under the given parent node. Preferably, in such embodiments the user has the option of selecting a subgroup of users whose ordinal rankings he or she can use to have the system compute such a normal ranking. It is also preferred that other factors can be weighted into the ranking, such as the time period in which rankings have been made.

As can be imagined, in a database comprised of many nodes which have been entered by many different users, and which any given node may have been ranked under multiple different parent node, the hierarchical view generated other database can vary considerably, depending on which group of users' rankings are used to generate the view.

FIGS. 4 through 6, illustrate some other possible data structures that can be used in the database 110.

FIG. 4 illustrates a node list 138 which is a list containing a nodeEntry for each separate node of the type shown in FIG. 3 contained within the database 110. As indicated by line 140, the node list 138 contains the following for each nodeEntry in the database 140: a nodeID 142, a childNodeIDList 144, a parentNodeUserEntryIDList 162, and a nodeContentID 172.

The nodeID 142 is a number or pointer that uniquely identifies the node represented by its node entry.

The childNodeIDList 144 is a list, as indicated by line 146 of FIG. 4, which contains a child node entry for each child node which is ranked under the node represented by its note entry. Each such child node entry contains a nodeID 148 for the child node having a user entry that ranks it under the current node, and a. userEntryID 160 pointing to each user entry which ranks the job note under be current node.

The parentNodeIDList 162 associated with the each node entry 140 contains a parentNodeEntry 164 for each parent node under which the current node is ranked. Each such parentNodeEntry includes a nodeID 166 of its associated parent node, and auserEntryID 170 for each userEntry which ranks the current node under that parent node.

Each node entry 140 also includes a nodeContentID 172, which accesses the contents of its associated node.

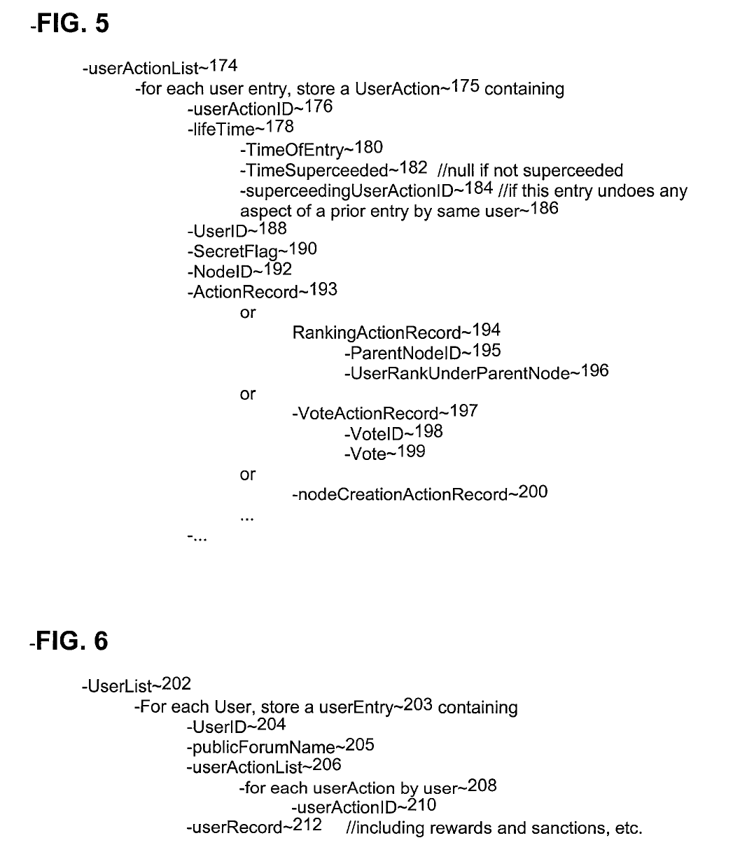

FIG. 5 illustrates the userActionList 174, which stores individual userActions 175. It should be understood, that in different embodiments of the invention userActions could be stored in different locations, including multiple different locations, such as under the nodes that they must directly affect, or by the users to enter them, or other time of their entry, or by other factors.

Each userAction 174 includes a userActionlD 176, a lifeTime 178, a userID 188, a SecretFlag 190, a NodeID 192, and an ActionRecord 193.

The userActionID 176 provides a pointer or a handle by which the userAction 175 is access.

The lifetime 178 includes a timeOfEntry field 180, a timeSuperceded field 182, and a supercedingUserActionID 184. The timeOfEntry 180 records the time at which the current userAction was entered into the system. The timeSuperseded 182 indicates a time, if any, at which the current userAction was superseded by a subsequent userAction from the same user, rendering it no longer effective. The supercedingUserActionID 184 provides the ID of any userAction that has caused the current entry to be so superseded.

Although it is not necessary in all embodiments of the invention, in the preferred embodiment of the invention user entries are kept after they are no longer effective, so that the system can to keep track of its past states. For example, users will often want to know the history of the database, and the history of individual nodes, or the past behavior of individual users within it.

Each userAction 175 also includes a userID 188, which identifies the individual user who has made the entry.

Each userAction includes a SecretFlag 190, which indicates whether the identification of the user stored in the userID 188 should be made available to other users. The purpose of this is to allow users to make statements without having their forum name associated with such remarks. This is not desirable in all embodiments of the invention, but in some embodiments of the invention which discuss controversial topics it may be considered desirable to allow users to enter all or a certain subset of their actions secretly, so they might feel more free to say things which they believe need to be said, or so they can act as a devil's advocate, without drawing undesirable criticism or ostracism.

Each userAction also includes a nodeID 192, which identifies the node upon which the action associated with the current userAction has taken place, and an actionRecord 193 which records the action associated with the userAction.

As is represented in FIG. 5, the ActionRecord can be a RankingActionRecord 194, a VoteActionRecord 197, a NodeEntryActionRecord 200, or other possible types of records not indicated in the figure.

If the ActionRecord is a RankingActionRecord 194, it will include a ParentNodeID 195 identifying the ParentNode under which the current node has been ranked by the ranking action, and the UserRank under the ParentNode, which has been associated with the current node by the ranking action.

If the action which the userAction represents is a Vote, a VoteActionRecord 197 will be included which includes a VoteID 198 identifying the particular Vote which is associated with the entry and an actual position taken in that vote, indicated by the Vote field 199.

If the action associated with a given userAction is the creation of a Node, a NodeCreationActionRecord 200 will be created to indicate that the action taken was the creation of the node.

FIG. 6 illustrates a userList 202, which includes for each user of the system a userEntry 203. Each such userEntry includes a userID 204, a publicForumName 205, a userActionList 206, and a userRecord 212 which can include different information in different embodiments of the invention. In the preferred embodiment of the invention is preferred that the user record include information about awards or credits, as well as sanctions or accusations, that have been associated with the users behavior.

The userID 204 is a pointer or handle that enables the system to identify and access a user.

The publicForumName 205 is a text string used to identify the user to other users of the system. As is common in public forums, many users will want to use a pseudonym so as to reduce the chance that they will be subject to hate mail, or that they will be hounded by crackpots, because of statements they make on the system. Users will be free, however, to use their own name, if they so desire.

In some embodiments of the invention, other forms of public identity may be associated with users, such as graphics, images, and photographs.

The userActionList 206 is a list of all of the given user's actions, which as is indicated by numerals 208 and 210 of FIG. 6, contains a userActionID for each such userAction.

The userRecord 202 includes other information about the user such as any rewards he has received, any sanctions he has received, and any other information that may be associated with individual users by the system. This could include information about the user, such as his demographic statistics, or statements about the user's beliefs, tastes, or desires.

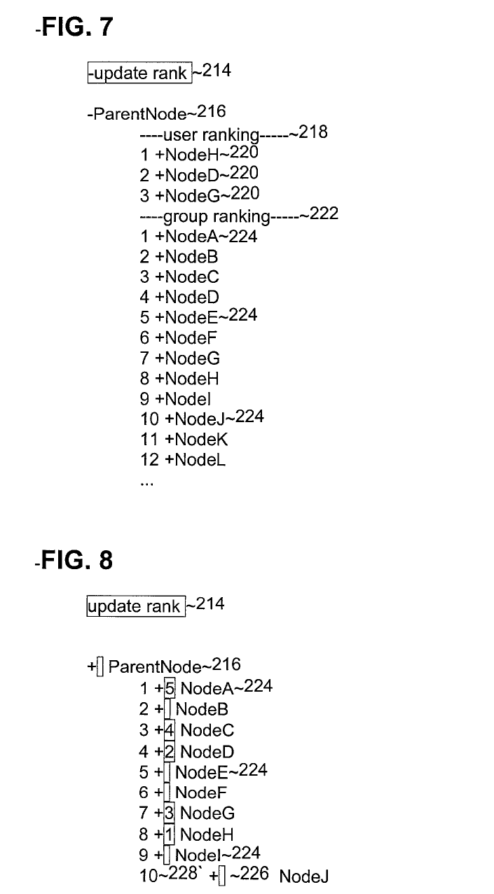

FIG. 7 illustrates how a user could ordinally rank nodes using a Drag-and-drop interface. Such an interface could be provided either by an applet running on the user's browser, by a downloaded application running under such browser, or by a browser which included features supporting such capabilities. The interface would allow a users to Drag-and-drop nodes which are shown ranked below the groupRanking 222 up to a region between that heading and the userRanking 218.

In FIG. 7 and many of the figures that follow, which like FIG. 7, represent a portion of a window on a browser screen, the portion shown is from a scrollable window, although the scroll bars are not shown in many such figures.

The Nodes 224 shown below the groupRanking are shown ranked ordinally under the ParentNode 216 according to the sum of such rankings provided by a selected set of users. The Nodes 220, shown under the userRanking portion of FIG. 7, are ranked ordinally under the ParentNode by the ranking given to them by the individual user seeing the view of FIG. 7. In such an interface, for example, the user would be able to select a node, such as the NodeH ranked number eight in the groupRanking 222, and drag it up to the top position under the userRanking 218 so as to cause it to be the first ranked node according to his opinion.

The purpose of such ranking is to let individual users provide to the system an indication of the relative importance they ascribe to individual nodes that have been ranked under a given ParentNode. As will be described below, the system has the capability to combine the rankings under a given ParentNode from the members of a selected set of users so as to let a user to see under the groupRanking portion of his display to see how the members of that group, as a whole, rank in importance or relevance the various nodes which have been placed under that ParentNode. This enables a user to quickly see what a given set of users, including the set of all users, if desired, consider to be the most important information under any given particular topic, or ParentNode, 216.

Once a user has ranked a set of nodes as is shown in FIG. 7, he or she can then press the update rank button 214 provided on his display so as to cause the ordinal ranking information which he or she has defined under the UserRanking 218 to be uploaded to the server. This information is stored in the server's database 110 shown in FIG. 1 as a separate userAction 175, of the type described with regard to FIG. 5, for each node which the user has ranked for the first time or has changed the ranking of. The userAction for each such ranked node will include a NodeID 192 identifying the node and a rankingActionRecord 194 idenfying the ParentID of the parent node under which the node has been ranked and the individual rank which the user has associated with the current node under the parent node.

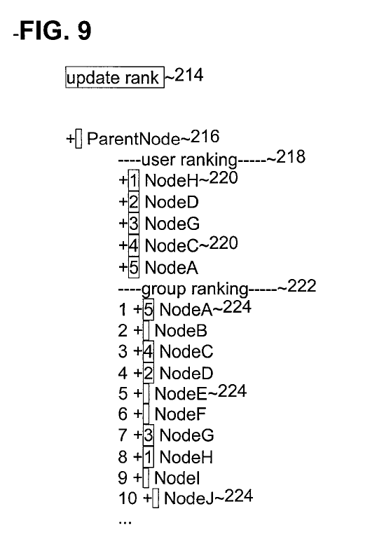

FIGS. 8 and 9 illustrate how the ranking process shown in FIG. 7 can be provided by for browser having a more primitive interface.

In FIG. 8 the Nodes 224 are shown ranked in terms of a view group, that is a selected group of users whose rankings are used to order the nodes under a given parent node. In FIG. 8 the rank of each such node is indicated by a ranking numeral 228. Preferably the user can elect whether or not such ranking numerals are shown.

In the embodiment of the invention shown in FIGS. 8 and 9, a user enters into the field 226 associated with any node the rank which he desires for that node and then presses the update rank button 214. As was described above with regard to FIG. 7 this will cause the user ranking information entered by the user to be uploaded to the server, causing it to be entered into the server's database as one or more userAction 175 of the type shown in FIG. 5.

In the example shown in FIG. 8 it is assumed the user has given his first placed ranking to NodeH, his second place ranking to NodeB, his third place ranking to NodeG, his fourth placed ranking to NodeC, and his fifth place ranking to NodeA.

In different embodiments of the invention different ways can be found for dealing with what happens if the user gives the same rank to two different nodes, such as by giving a rank to a node under the groupRanking heading which corresponds to a rank which he has previously given to a node already under his own userRanking heading. In some embodiments, the server or the client could send the user a message informing him that he has given the same rank to multiple nodes. In other embodiments, if the user gives a given rank of a node which she has previously given to another node, the system will automatically lower by one the ranks of all user ranked nodes having a given rank or below under the same ParentNode.

In an embodiment of shown in FIGS. 8 and 9, a user can type a blank into a RankingField 226 associated with a node, either in the groupRanking 222 or the userRanking 228 shown in FIG. 9, to indicate his intension for the node to become unranked under the current parentNode.

When the user presses the update button 214, the server will generate a new image of the page, such as that shown in FIG. 9, showing both the userRanking 218 and groupRanking 222 of nodes under the current parent node. Of course, if the number of users in the view group being used to determine the group ranking is relatively large, a given user's changes will often not have a visible effect upon group ranking.

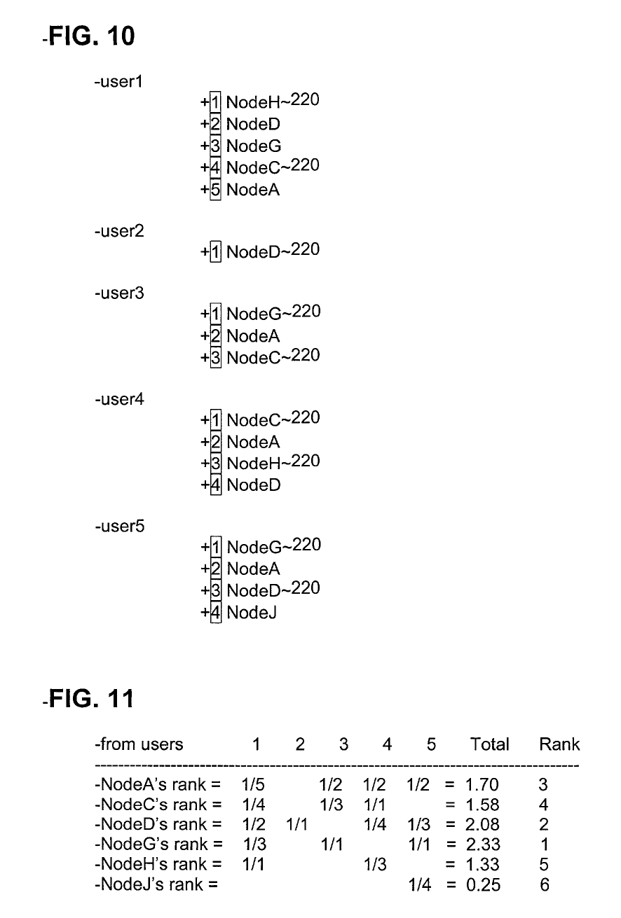

FIGS. 10 through 14 are used to illustrate how the rankings from individual users can be combined to generate a group ranking for a given set of users, and how the group ranking generated for different sets of users will vary.

FIG. 10 illustrates a set of five different ordinal rankings created by five different users, user1 through user5. For each such user the ordinal ranking can be produced by a method similar to that described above with regard to FIGS. 8 and 9.

FIG. 11 illustrates how a group ranking can be calculated from the individual ranking show in FIG. 10 for a group comprised of each of the five users shown in that figure.

In the preferred embodiment of the invention, group rankings are calculated by assigning to each node under a given parent node a rank value corresponding to the inverse of its ranking under that parent node. In other embodiments any other formula that performs a proper job of combining individual ordinal rankings into one combined ordinal ranking can be used.

For example, group rankings can be calculated for individual nodes based on the sum of one over the rank given to that node by each individual raised to a fractional power (such as one divided by the square root of the individual user ranking). If this is the case, the less the fractional power, the more relative weight will be given in the sum to lesser rankings.

Calculating group ranking as a sum of a reciprocal function of individual rankings has the advantage of dealing nicely with node that receive no ranking from an individual. But using such reciprocal methods is not necessary, and many other types of ranking methods could be used.

For example, user group rankings could be performed by summing for a node the ordinal rank given by each user in the group to that node, with some arbitrarily low rank given in the case that the node is not ranked at all, and with nodes having the lowest resulting sums being ranked highest.

For another example, a user could rank nodes by assigning them a weight between 0 and 100, with nodes having a higher weighting being ranked higher for the user. In such a case, group rankings could be calculated by summing the weights assigned to each node any users, and then ranking the nodes based on the sums associated with each, with the nodes having the highest sums ranked highest.

In some embodiments, ordinal rankings might be weighted by other factors, such as an importance or agreement value which a user associates with a node rather than a simple ordinal rank, the recency of each ranking, a rank or weight associated with the individual making the ranking, the extent to which the user making the ranking matches the voting and/or ranking profile of a given group for which the ranking is being made

As is shown in FIG. 11, the group rank for NodeA is determined as the sum of the following numbers: ⅕ because the node was ranked fifth by the first user, ½ because the node was ranked second by user3, ½ because the node was ranked second by user4 and ½ because the node was ranked second by user5. The node receives no ranking value from user2 because he did not rank it. As a result NodeA receives a total ranking value of 1.7.

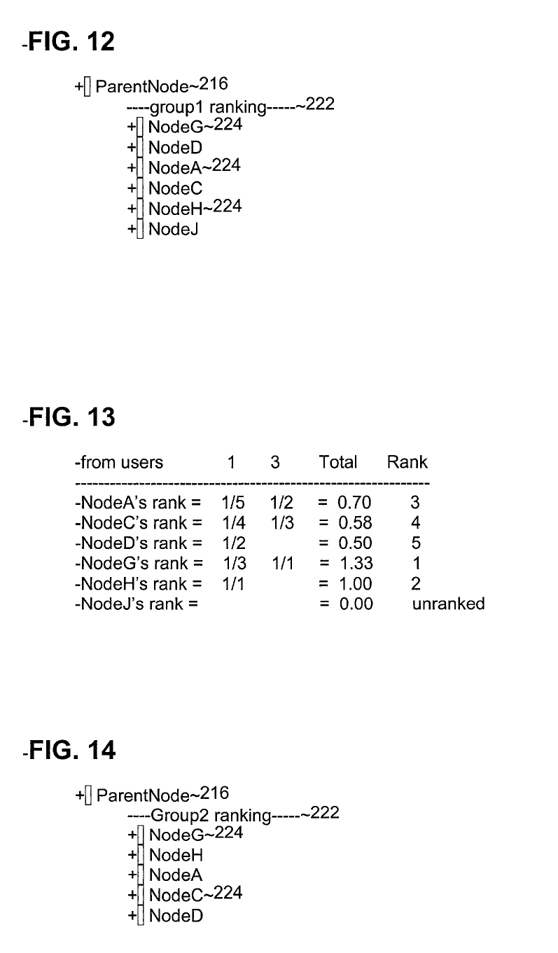

A similar method is used in FIG. 11 to calculate a total rank value for each of the nodes shown in FIG. 10. As is indicated in FIGS. 11 and 12 this causes NodeG, NodeD, NodeA, NodeC, NodeH, and NodeJ to be ranked, respectively, one through six for group1.

FIGS. 13 and 14 correspond to FIGS. 11 and 12, except in these latter two figures the view group for which group rankings are calculate and shown is group2, which is comprised only of users1 and 3, whose rankings are shown in FIG. 10. As can be seen from FIGS. 13 and 14 this change in the group for which group ranking is calculated causes the rankings to vary considerably.

The ability of the system to project the different rankings of importance or significance which are associated with different groups of users is important because it helps to enable users of the system to see the relative priorities of different groups, and because it enables the user to see nodes ranked by groups who share his opinion on other issues and thus who are likely to bring to the forefront nodes which are likely to be of interest to him or her.

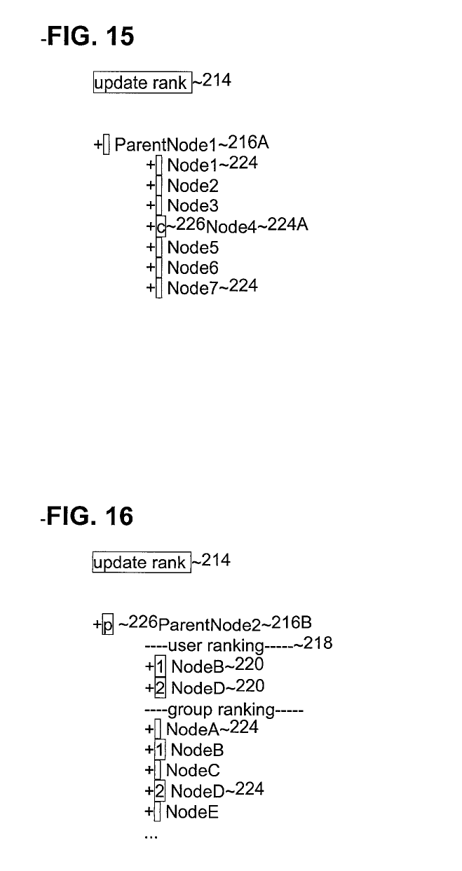

FIGS. 15, 16 and 17 illustrate how a user can elect to rank a node currently shown under a first parent node under another, second, parent node using a relatively primitive form field-based interface. In other embodiments more advanced interfaces could be used to allow a user to copy nodes from under one parent node to under another.

FIG. 15 shows a group of Nodes 224 which have been ranked by a view group under a ParentNode 216A. In this primitive user interface the user can type a character into the field 226 located in front of the node he desires to copy and rank under a different parent heading. The user can then press the update rank button 214. This will upload to the server information that the user desires to copy the Node 224A, causing the server to save that information in a clipboard for future use. In some embodiments this information could be stored in the client itself.

FIG. 16 shows how the user can paste a node which has been previously copied, as shown in FIG. 15, under a new ParentNode 216B by typing text into the field 226 indicating that the user wishes to paste under that ParentNode 216B whatever node is currently stored in the clipboard. Once this has been done the user can click the update rank button 214.

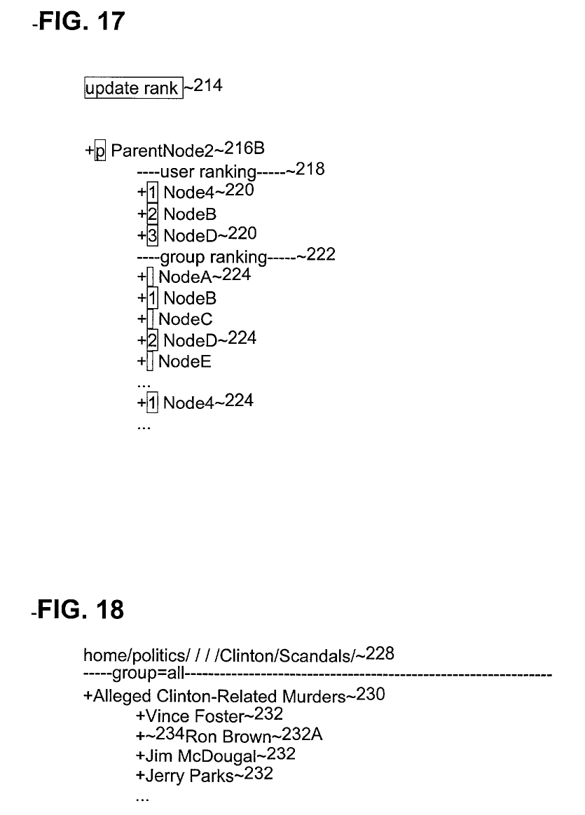

In this case, clicking on the update rank button will causes information identifying that a paste is to be made under the given parent node to be sent to the server. In response the server will create a new userAction 175 of the type shown in FIG. 5, which will have a RankingActionRecord 194 indicating that the node copied is to be ranked under the new parent node. Although it could be done differently in other imbodiments, in the current embodiment the system will cause the new node to be ranked first in the user ranking under the new parent node. In response to this new ranking under a new parent, the server will generate a new page as is shown in FIG. 17 which shows the new ranking of the Node4 (the node copied in FIG. 15) under the userRanking under the new ParentNode 216B shown in FIG. 17.

It should also be understood that in different embodiments of the invention many different types of media could be used and ranked, such as text, graphics, images, audio, video, or a combination of medias. It should also be understood that the present invention can be used to collaboratively order media on many different types of subject matter, including movie ratings, jokes, product rankings and descriptions, opinions about sports teams and players, advice or wisdom about raising children, taking care of pets, matters of the heart, matters of religion, popular culture, the arts, or virtually any other topic which can be discussed.

Although the invention can be used to organize and display media on many different types of subject matters, one area in which it can be particularly useful is in a forum designed for the intelligent discussion of political and social issues. This is because the invention has the capability of bringing together what appear to be the most important arguments from different viewpoints and because it also lets one see how different groups of people view the same issues.

Many of the figures that follow illustrate an embodiment of the invention for use in such a political and social issue forum.

FIG. 18 shows view that might be generated for part of a database dedicated to discussion of political issues.

This view includes a path control 228 at the top of the view to give the user a feeling of where she or he is in the outline. In this path control the user can click on any slash to toggle between seeing the node in front of it represented by a space or by the node's name. This enables the user to expand or contract the representation of the path to a desired length and to obtain whatever information from it he or she desires. The user can also click on the name or space associated with any node in the path control to see a view of that particular node of the database.

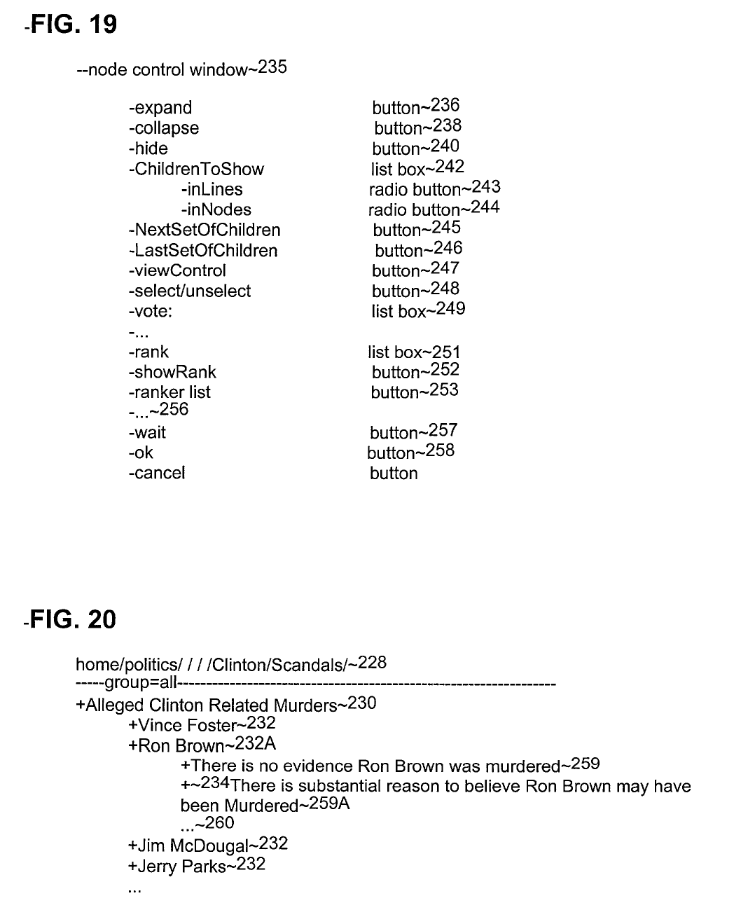

The top node shown in FIG. 18 is a Node 230, which is a heading node, describing what is to be discussed underneath it. Under this heading node there are multiple sub-headings 232. At the front of each node is a node control 234 which can be used to control the view of the node. If the user clicks on such a node control, a node control window having the contents represented schematically in FIG. 19 is shown. In some embodiments this window could be downloaded from a server, but preferably it is generated by code, such as a Java application, residing on the browser to enable it to be displayed more quickly.

FIG. 19 shows that the node control window 235 includes an expand button 236 which allows the user to expand the node whose node control 234 has been clicked, causing one more level of descendant nodes from it in the outline to be displayed.

The collapse button 238 performs exactly the opposite function, reducing by one the number of generations of descendant nodes that will be displayed under the current node.

The hide button 240 will cause the current node to be hidden.

The ChildrenToShow list box 242 is a list box which lets the user define how many lines of children nodes or how many actual children nodes the user wishes to display under the current heading, depending on which of the radio buttons 243 or 244 are set. This is an important feature because many nodes in the outline might have hundreds or even thousands of nodes ranked under them and, in such cases, a user may wish to see an overview of a given area in the outline in which only the top ranking items under each of a set of sibling nodes, that is nodes having the same level under a parent node, are shown.

The NextSetOfChildren button 245, if pressed, causes a set of the next lowest ranking child nodes to be shown under the current parent, with the size of the set being defined by the ChildrenToShow listbox and the radio buttons under it. The LastSetOfChildren button 246 performs just the opposite. Together these two buttons let a user scroll up or down within the list of ranked children under current node for which the node control window has been evoked.

The viewControl button 247 calls up a window, which contains even a larger set of controls for determining the view of the current outline under the current node.

The select/unselect toggle button 248 allows the user to select or unselect the current node. This is useful because many of the commands in the user interface are performed upon a selected node, such as a cut or paste.

The vote list box 249 allows the user to select how she wishes to vote on the node, if the node is of a type that can be voted upon. As is described below, it is preferred that different types of nodes be able to have one or more different types of votes, such as: “Agree/Disagree: Yes/No/Undecided”; “Agree/Disagree: −10 to 10”; “WorthSeeing: yes/no/undecided”; and “Important/Unimportant: 0 to 10.

The rank list box 251 enables a user to select the desired ranking for the current node under its current parent. This allows a quicker form of ranking than that shown above with regard to FIGS. 8 and 9 since it can be performed entirely by mouse, rather than requiring the use of the keyboard.

The showRank button 252 is a toggle that allows the user to determine whether or not rank numbers are placed in front of each node, such as the rank numbers shown in FIG. 8.

The ranker list button 254, if pressed, will display a window or page which will provide information on which users have ranked the current node and the history over time of that node's ranking by different users. It will also include links or buttons that will enable a user to select the group of users who have taken different types of ranking actions with regard to the current item. Once such a user group is selected, the user can see how that group has ranked nodes under one or more topics or can or can send messages to such users, such as to solicit their help in promoting or opposing the ranking of or voting for another node.

As is indicated by the numeral 256 in FIG. 19, other items could be included in the node control window. Similarly, items contained within this node control window could be placed elsewhere in the other user interfaces at the discretion of one creating a particular embodiment of the invention.

The node control window of FIG. 19 also includes a wait button and an ok button, 257 and 258, respectively. If the wait button is first pushed, then the action of a button selected in the window is delayed until the ok button is pushed. This is desirable if the user wants to make multiple setting changes at once. When the ok button is pushed, any selections made list boxes or radio button in the node control window, and any actions that have been put on wait by the wait button 257 are executed.

FIG. 20 shows the view of FIG. 18 after the user has used the node control of node 232A of FIG. 18 and the expand button 236 of FIG. 19 to expand the heading 232A with the ChildrenToShow listbox 242 set to two and the In Nodes radio button 244 shown so that only the top two ranked nodes under that heading are shown. The ellipses 260 is used to indicate to the user that there are more sub-nodes under the heading 232A, and clicking on those ellipses will have the same effect as clicking on the NextSetOfChildren button described above with regard to FIG. 19.

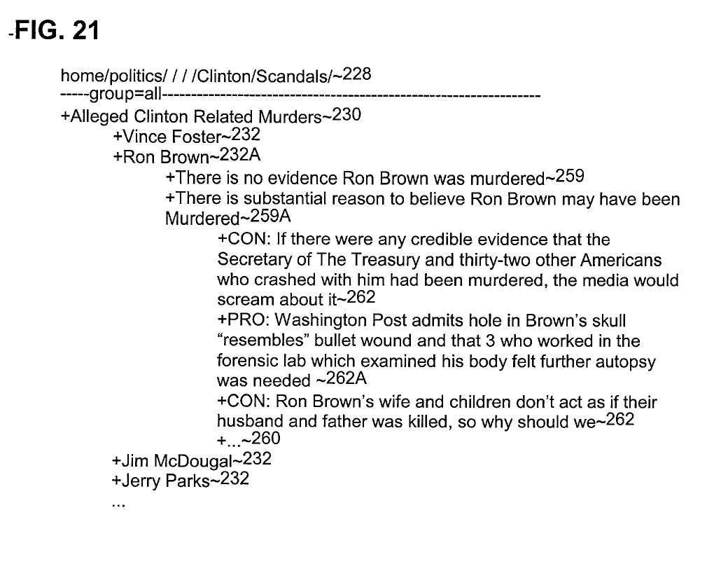

FIG. 21 shows how the views shown in FIG. 20 will be regenerated if the user clicks the node control 234 associated with the Node 259A shown in FIG. 20 and clicks the expand button 236 shown in FIG. 19 with the ChildrenToShow listbox set to three and the InNodes radio button 244 set.

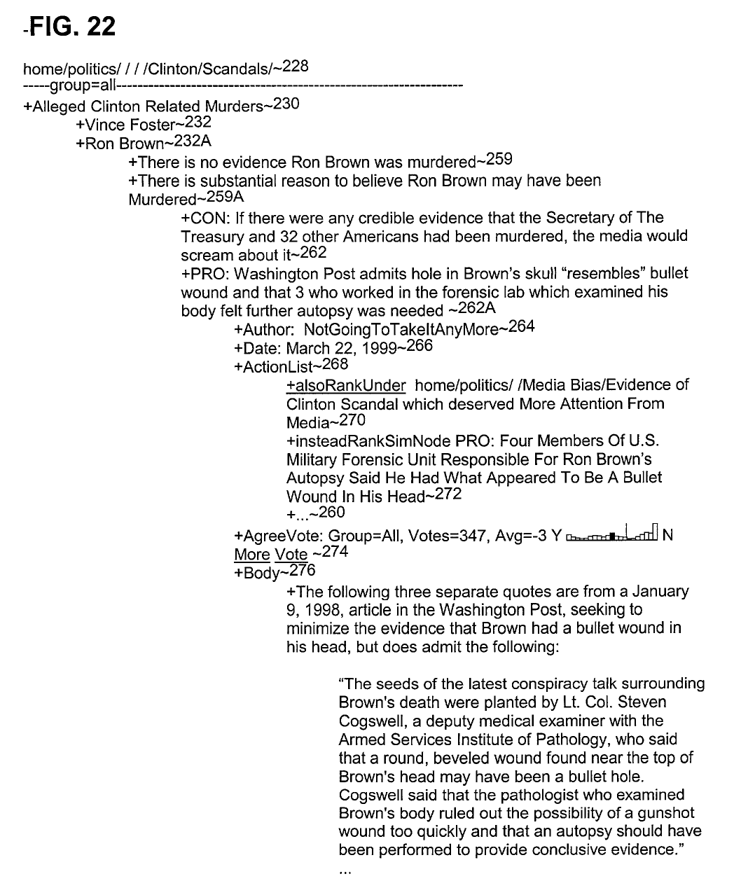

FIG. 22 provides an example of what the view shown in FIG. 21 might look like if the user expands the view under Node 262A using the expand button 236 shown in FIG. 19 and also uses the view controls accessed by use of the button 247A in FIG. 19 to more finely select how the view under the topic 262A is to be shown.

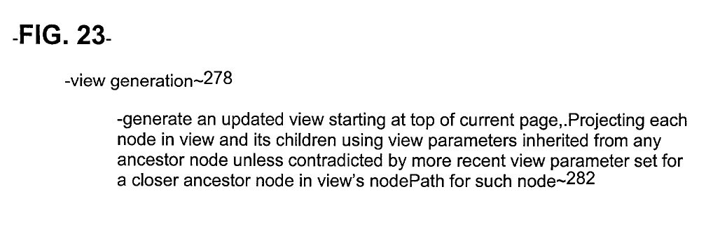

FIG. 23 is a schematic representation of a view generation routine 278, which is used to generate a new view for the client computer. If the user changes view parameters or changes the view content, such as by moving to a location not included in the previous view, then step 282 will be performed. Step 282 generates an updated view starting at the top of the current page. The top of the current page will often be the same top that the previous current page had unless the user's change of view parameters or navigation within the database has caused that to change. In many embodiments of the invention, a view is converted into an HTML web page, and often will be considerably longer than what will fit on one screen at a time. In such case the view is shown with a scroll bar to enable a user to change his location within that view page. Of course in other embodiments of the invention, where the client has greater capabilities, views might actually be generated dynamically for each screen shown to a user. Step 282 projects each node in the view and its children, using the view parameters inherited from any ancestor nodes, unless those view parameters are contradicted by a more recent view parameter set for a closer ancestor in the view's node path for the given node. This is rather equivalent to the use of cascading style sheets in XML view generators.

In some embodiments of the invention, each new view will be generated as an HTML page by the server and downloaded to the browser. In client systems having an XML to HTML page generator of the type shown in FIG. 2 which operates as a plug-in proxy for a browser 112, the proxy 114 can actually generate the HTML pages in response to cascading view parameters supplied to it from the user through the browser 112 and it can use that information to generate new views of any XML data which it has previously been sent by the server, without requiring extra communication with the server. If, however, a requested new view requires additional data from the server, the proxy 114 need only request from the server as much information as is necessary or appropriate to generate the new view, thus reducing the amount of time required to generate minor changes in a view, such as, for example, a change like that between the view in FIGS. 18 and FIG. 20. Such a proxy could further speed the responsiveness of the system if the server routinely sent the proxy portions of the database which are likely to be requested by a user before they are requested, so that when the user request to view any such already-downloaded portions of the database, the proxy will be able to display them virtually instantaneously.

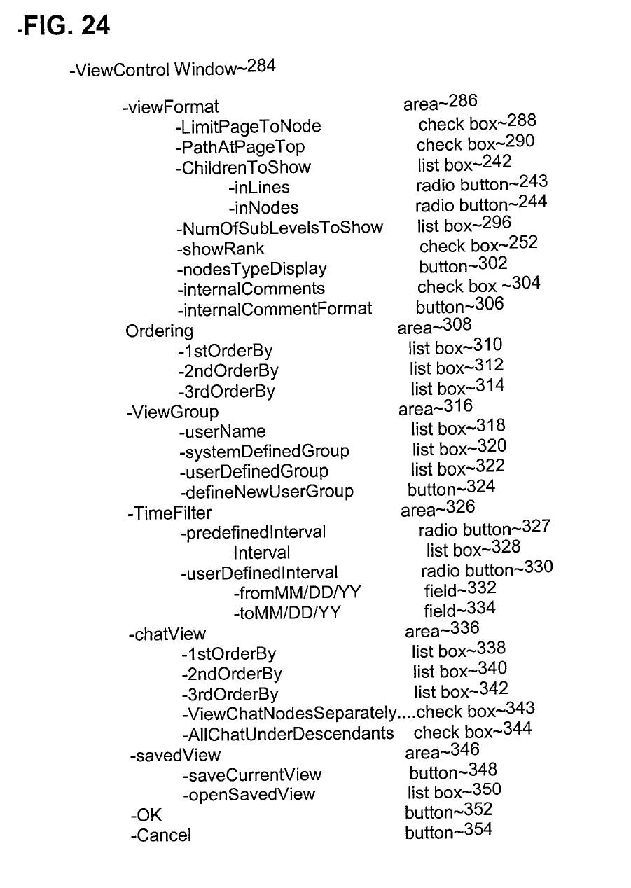

FIG. 24 illustrates a view control window 284 which can be accessed, by pressing the viewControl button 247 shown in FIG. 19. This window enable a user to set more view parameters than those which can be set directly from the node control window shown in FIG. 19. The commands available in the view control window preferably vary as a function of the node for which it is called or the subspace within the database in which it is being used. The view shown in FIG. 24 would be appropriate for most common nodes.

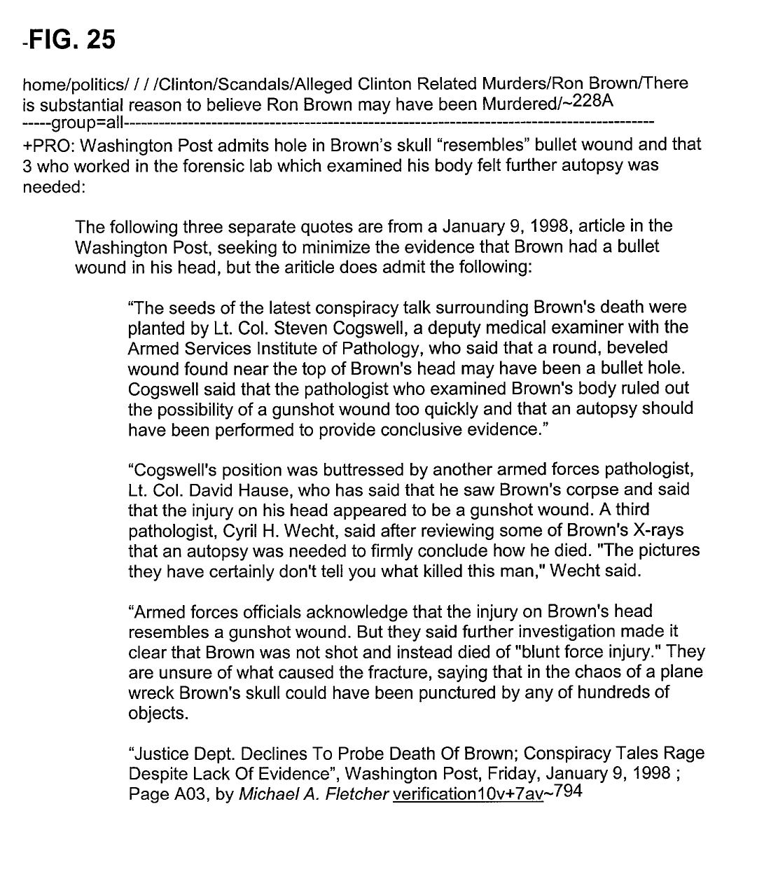

As shown in FIG. 24, the view control window includes a viewFormat area 286. This area includes a LimitPageToNode check box 288, which if clicked when the view control window has been called for a particular node will limit the view to that node and its descendants. FIG. 25 is an example of what would happen if this option were selected for the Node 262A shown in FIG. 22. seeSelection'sEntries button allows the user to determine how a given node has been indexed and to rank the importance or propriety of such indexing.

The enterSelectionUnderHeading button 1073, if clicked, will display an interface allowing the user to assign a rank for the current selection under an index heading, such as the heading 1080A shown in FIG. 69 which is currently selected within the indexViewWindow 1076 and it will allow the user to rank the node using traditional node ranking techniques.

FIG. 69 shows that when a node or internal selection is pasted under an index heading, a nodePath 1082 for the selection will be placed under the heading that will include an identification of any internal selection that might be associated with the current selection. This nodePath and selection, if any, will be in the form of a link which can be clicked by the user to be taken to its associated selected portion of the database in a view associated not only with the given node and its associated internal selection, if any, but a given nodePath, that is, a given ancestry within the node hierarchy shown in a view.

If the user clicks the indexViewControl button 1074, shown in FIG. 68, she or he will get a ViewControlWindow similar to that described above with regard to FIG. 24, except that it will be customized to control the view within the indexViewWindow. A similar indexViewControlWindow can be generated by clicking on the node control 234 for an index heading, except if the indexViewControlWindow is generated in that way its settings will only apply to the indexheading for which the node Control is clicked and its children.

If the user clicks on the go button 1075 associated with indexHeadingSearch text field of FIG. 68, the selection within the indexViewWindow 1076 shown in FIG. 69 will move to the first top level indexHeading node which contains all, or the longest initial sub-portion of, the text contained in the indexHeadingSearch text field. It is intended that the indexViewWindow be a scrollable window in which a user can a hierarchical set of ordering criteria, which can be used to order sub-nodes under the current node. Such ranking criteria can include user ordinal ranking of the type described above with regard to FIGS. 7 through 13, or it can include ascending or descending date, author name, magnitude of rank change, number of votes cast, number of yes votes, number of no votes, and other criteria.

The ViewGroup area 316 of FIG. 24 is designed to help a user define and select a view group, that is a group of users whose ranking or activity will be used to order child nodes under the current node.

The userName list box 318 allows the user to select the forum name of any user of the system. The systemDefinedGroup list box 320 allows the user to select any group that has been previously defined by the system. The user groups listed in this list box can include groups defined by administrators of the system, groups defined by mathematical techniques such as clustering, so as to divide users into major divisions and sub-divisions according to similar patterns of behavior, or groups defined and used by enough users to have been adopted by the system as a whole.

The userDefined list box 322 allows the user to select from among a list of groups which he or she have previously defined using the defineNewUserGroup window accessed by pressing the button 324, shown in 24.

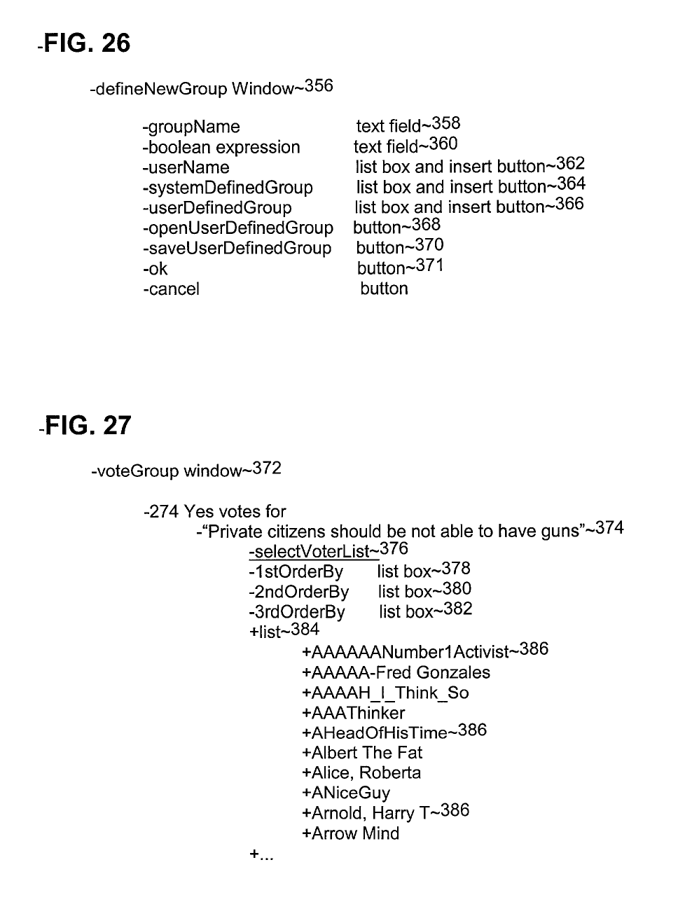

FIG. 26 illustrates a defineNewGroupWindow. This window includes a groupName text field 358 into which the user can enter the name of the new user group he is seeking to define. It includes a Boolean expression text field 360 into which the user can enter a combination of group definitions combined by Boolean operators, such as AND, OR, and NOT, so as to define complex group definitions. The group definitions which can be used as individual terms in the Boolean expressions entered in the text field 360 can be selected from the userName list box 362, the systemDefinedGroup list box 364, and/or the userDefinedGroup list box 366, which, respectively, enable the user to select individual user names, system defined groups, and/or user defined groups. The user can also enter as a terms in the Boolean expression windows a group of users who have taken a given action on a given node, such as can be obtained from a rankers list of the type described above with regard to button 253 in FIG. 19, or by a selectVoterList link 376 of the type shown in the voteGroup window 372 of FIG. 27, which enables a user to see and select the group of users who have voted in a given way for on a given node. The vote group window lets the users see a list of the members who have taken a certain action ordered by a hierarchical set of criteria defined by list boxes 378 through 382, which correspond to the list boxes 310 through 314 described above with regard to FIG. 24. It also allows the user to select individual users who have taken such a vote and to examine the information available to on each such user including their action history.

Returning now to FIG. 26, once the user has entered a desired Boolean expression in the text field 360, the user either can save that definition by clicking the saveUserDefinedGroup button 370 or can click the ok button to cause the group defined in the Boolean expression field to be treated as the currently selected group.

As is indicated by the openUserDefinedGroup button 368 of FIG. 26, the user has the option of opening previously defined groups, editing their associated Boolean expression, and then saving them, as edited, under their old name or under a new name.

Returning to FIG. 24, the view control window of that figure includes a TimeFilter area 326, which enables the user to define a time period during which user actions are to be taken into account in generating the view. The user has a choice whether to select a predefinedtimeinterval or a userDefinedinterval with the radio buttons 327 and 330. If the pre-defined interval radio button is selected, the user can then select an Interval from a list box 328 which has choices such as last hour, last day, last week, last month, last year, since start, and various recent calendar weeks, months, and years. If the user selects userDefinedInterval with the radio button 330, he or she can use from and to text fields, 332 and 334, respectively, to define the start and end date of the interval.

Time filtering is useful because it allows the user to see how rankings or activities on subjects have changed over periods of time. It is particularly useful in letting the user focus on changes occurring in the database over a recent time period.

In other embodiments of the invention, separate time filters could be associated with each of the ordering criteria selected in the Ordering area 308. In the embodiment shown different time filtering criteria can be placed on the children of different nodes of the outline.

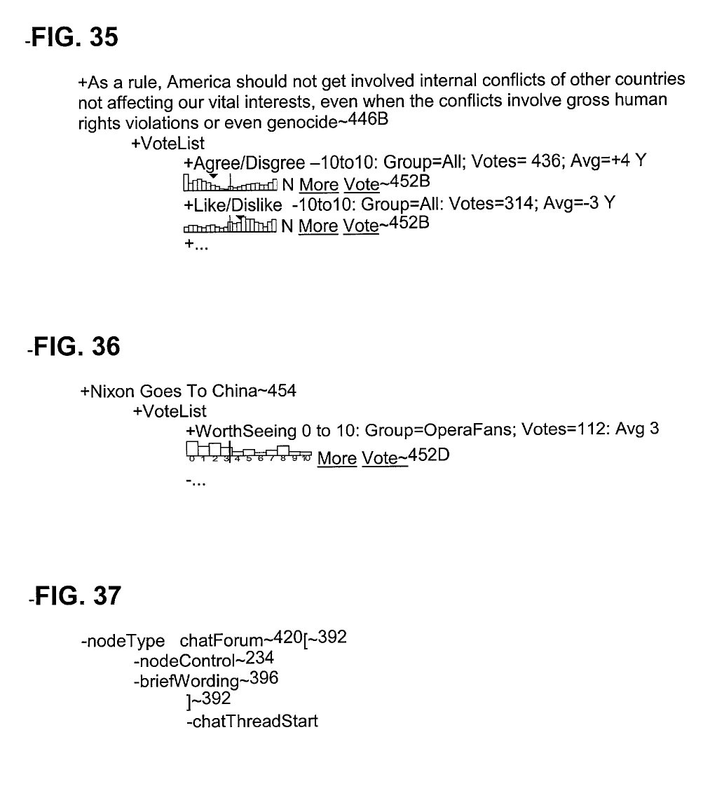

The view control window of FIG. 24 includes a chatView area 336, which lets a user control how threaded chat is viewed, if at all, within portions of an outline he is viewing. As will be described below with regard to FIG. 37, one of the node types of the outline is the chatForum node type. These are nodes under which a user can create one or more chatThreadStart node, each of which can have under them one or more chatResponse nodes. In other embodiments of the invention there need not be any distinguish between chat nodes and other node types. But in the present embodiment chat has been separated from other types of heading so as to allow chat to represent a more quickly produced, but less carefully crafted from of communication. However, the current embodiment allows portions of chat to be copied into other types of nodes within the database.

The chat view area of FIG. 24 is designed to control the view of chat nodes under a chat forum node under the current node for which the view control window has been selected.

The chat view area includes 1^{st}, 2^{nd}, and 3^{rd} OrderBy list boxes 338 through 342 which enable a user to select a hierarchical ordering criteria for all chat threads under all chatForum nodes occurring under the current node. Such rankings include ranking by ascending and descending date, by user ranking, by author name, and by other criteria. It should be appreciated that if the user selects to see chat ranked first by descending date, then the most current chat threads will be generated at the top of each chat forum. In embodiments of the invention having push technology, chat forums ranked by descending date order could be shown as dynamic windows in which chat could be interactively shown as entered.

The ViewChatNodesSeparately check box 343, if selected, will allow individual chat response nodes to be ordered independently of their parent nodes in a chat thread, allowing the dynamic window discussed at the end of the last paragraph to provide a totally chronological view of chat. When this option is selected, each chat response node will be labeled with an identification of the chat node is being made in response to.

The AllChatUnderDescendants check box 344, if selected, will cause all the chat generated in any chatForum nodes under the current node and any of its descendants in the given outline view to be combined under the chatForum node of the current node. This is helpful in that it allows one to monitor all the chat that is occurring under a given node, even if that chat is occurring in chat forums associated with sub-nodes of the current node. When this option is chosen, each chat node displayed will be labeled by an identification of the path within the current view of the chat forum node under which it is been entered. When chat threads ranked under deferent chatForums are viewed combined under one chatForum, the ranking under the one chatForum can be performed as described above with regard to FIGS. 10 through 14. This will cause each node's rank in the combined view to be the sum of the inverse of its rankings by individual users under each separate chatForum whose threads are being combined for the view. In other embodiments other methods of combining could be used.

In other embodiments of the invention, users are provided a similar capability to combine together the ranking of nodes under multiple individual parent nodes other than chatForums and indexHeadings, as is described with regard to this embodiment.

The savedView area 346 in viewControl window of FIG. 24 includes a saveCurrentView button 348 and an openSavedView list box 350. These allow users to name the settings associated with the current view of the current node and any of its sub nodes that are displayable according to such settings, and to save them under that name. Once such views have been saved, the openSavedView list box 350 allows the user to reactivate a formerly saved view. This is valuable because in a complex hierarchical data space, such as that which will be associated with many embodiments of the invention, a tremendous amount of time can be saved by having a set of pre-defined views that allow a user to view a node and its sub-nodes in a desired set of one or more selected formats.

Finally, the ViewControlWindow of FIG. 24 includes an OK button 352 and a Cancel button 354. The OK button causes the current values set by the controls described above with regard to FIG. 24 to be put into effect for the current node. The cancel button allows the user to cancel out of the view control window without changing any of the current view settings.

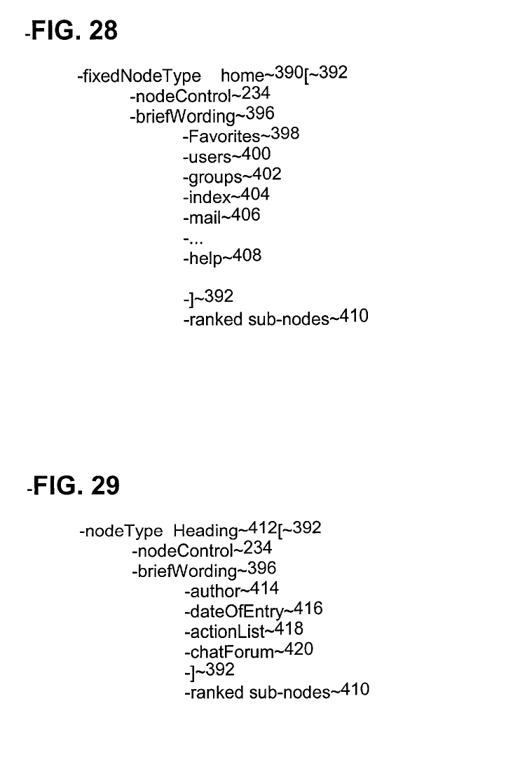

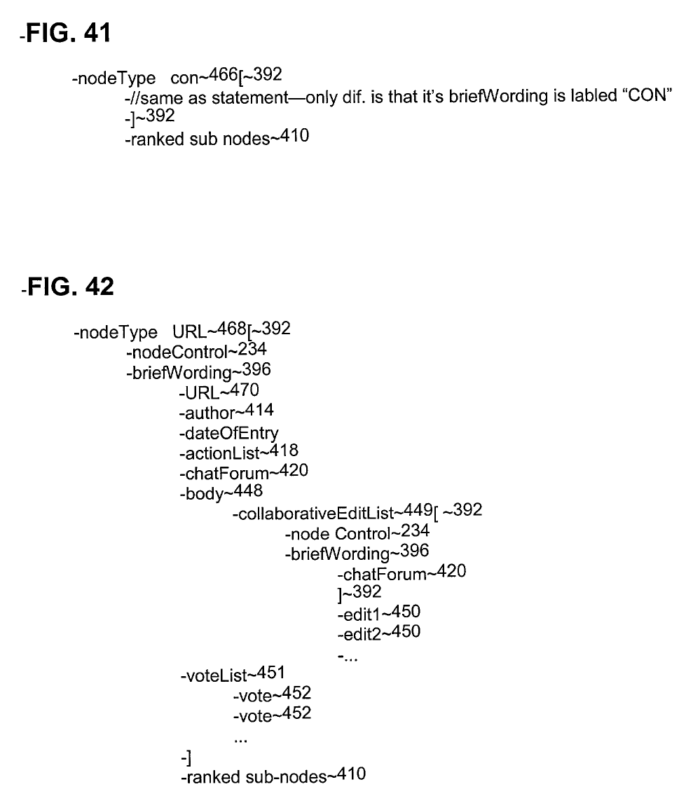

FIGS. 28 through 41 are used to describe some of the basic node types which can be used in an embodiment of the invention in a database designed to provide discussion of various topics, including, but not limited to political and social topics.

In these figures, the portion of the node definition between square brackets “[” and “]” 392 identifies the sub-nodes or components of the node that are a fixed part of the given node. The nodeTypeDisplay button 302 shown in FIG. 24 enables the user to determine whether or not many of the fixed sub-nodes of a given node will be displayed in a given view or whether or not they will be displayed in a compressed form. For example, in FIG. 22 most of the fixed nodes under the node 262A are displayed. This often provides more information than is desired, and, thus, users will often select to hide many fixed nodes or to represent them in a more compact representation, such as with small icon links.

In some embodiments of the invention node types will be defined by the administrators of the system. In other embodiments users could be allowed to define new node types and also to collaboratively define the fixed sub-node which are automatically associated with a given node type, such as by associating an ordinal importance ranking to each such node type or by filtering them by usage.

FIG. 28 describes the home node 390, which is the root node for the database 110 in some embodiments of the invention. The home node is a fixed node type, meaning that it is not a node that can be moved by the user within the outline. The fixed portion of the home node located between square brackets includes a nodeControl 234 of the type shown in FIG. 18 and associated with most individual nodes when they are displayed in a view. The home node also includes a briefwording 396, which, in the case of the home node, is the text “home”. The home node then includes a set of fixed sub-nodes, which are indented underneath it.

In the preferred embodiment these include a Favorites node 398, a user's node 400, a group's node 402, an index node 404, a mail node 406, and a help node 408. The favorites node 398 includes a private sub-portion of the data structure into which the user can enter or copy desired nodes and organize them in any way he desires. For example, the favorites node could include sub-nodes under which a user would place URLs of websites of interest to him as well as links to portions of the database he commonly visits. The users node 400 contains a list of the system's users that can be viewed by various orderings. The groups heading 402 includes a listing of all of the system-defined and user defined groups available to the users. The index heading 404 contains the collaboratively created index for the database. The mail node 406 includes in-box and sent messages subheadings for internal mail. Internal mail is mail generated within the system from one user or group in the system to another user or group within the system. Such mail is commonly used to help organize the collaborative choice of wording for topics and articles, as well as their promotion to a relatively visible place within the ranking structure of the database. The help node 408 includes explanations of how to use the system.

As is indicated in FIG. 28, under these pre-defined subheadings of the home node, user ranked sub-nodes 410 can be placed by methods similar to or analogous to those described above with regard to FIGS. 7 through 17.

In other embodiments of the invention a system might have multiple sub-root nodes rather than one single root node. Also in other embodiments, the fixed set sub-nodes of the root node can be displayed in other than in an outline format, such as in a quasi-menu appearance or as a set of clickable nodes in a more free form user interface.

FIG. 29 illustrates a Heading node 412. A heading node is intended to be a node whose purpose is to define the subject to which the nodes indented underneath it pertain. In the embodiment shown in FIG. 29 each heading node includes a nodeControl 234 and a briefwording 396 similar to that contained in the home node described with regard to FIG. 28, except that the briefWording of a heading node is chosen by the user who creates it. The fixed sub-nodes of a heading node include an author node 414, which identifies the user who has created the node; a dateOfEntry node 416, which identifies the date on which the node was created; an actionList 418, which lists alternate actions which other users have taken with regard to the node; and a chatForum node 420, under which threaded chat can be entered by users.

After the fixed sub-nodes associated with a heading node, the user can enter ranked sub-nodes, which will commonly include heading or statement nodes.

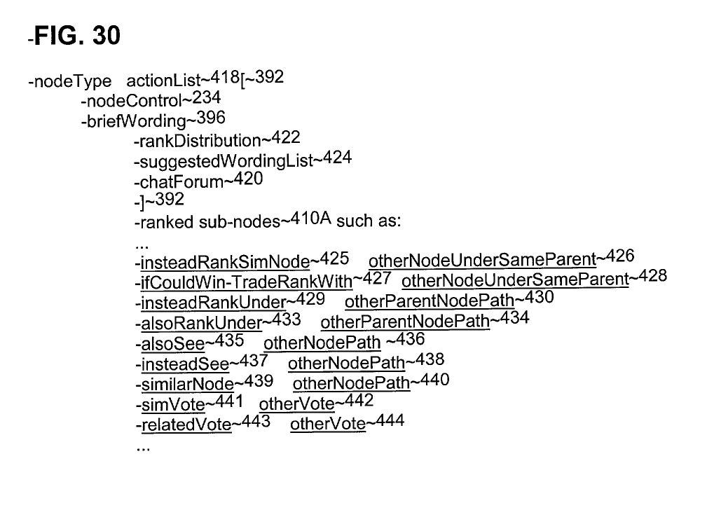

FIG. 30 illustrates an action list node definition. The actionList node 418 includes a nodeControl 234 and a briefWording 396 like most other nodes. In the case of the action node, the brief wording is the string “actionList”.

The fixed sub-nodes associated with an action list node include a rankDistribution node 422, which if clicked will provide one or more graphs indicating the distribution of ranking of the current node for the given view group over different periods of time and which will include links and controls for selecting such graphs.

In the case where the actionList node 418 is under a node that has a user definable brief wording, the action list also includes, as a fixed sub-node, a suggestedWordingList 424. The suggested Wording list is a user ranked list showing suggested changes in wording for the brief wording of the node under which the action list occurs. In some embodiments, the brief wording is automatically changed to match the best-ranked suggested wording contained in its suggested wording list. In other embodiments, the suggested wording list merely provides suggestions for how to create a new node that would have wording that might be more attractive or more persuasive to users. Finally, an actionList node contains a chatForum node as a fixed sub-node under which users can have place chat threads relating to suggestions for actions on the current node, i.e., the actionList's parent node.

FIG. 30 shows that, below the action lists fixed sub-nodes, user ranked sub-nodes 410A can be added and ranked by users of the system. In the case of an actionList node, such sub-nodes can include special pre-defined node types designed for use in action lists. These can include, for example, the pre-defined nodeTypes 426 through 444, shown in FIG. 30.

The insteadRankSimNode node type 425 shown in FIG. 30 indicates that one or more users are suggesting that instead of wasting a relatively high ordinal rank upon the current node it would be better to instead allocate such a rank to another node under the same parent indicated by the link 426. If the user clicks on the link 426 she will be able to see the other node under the same parent that the insteandRankSimNode entry suggests should receive a high ranking instead of the current node with which the action list is associated. If the user clicks on the wording insteadRankSimNode, itself, the system will automatically execute the node's suggestion. This is, it will remove the ranking, if any, which the current user has given the current node and open up a window asking the user what rank she wants to ascribe to the other node 426 under the current parent. If a user does click on the insteadRankSimNode button, that action will be recorded in association with that node and will be used to increase its relative ranking within the current action List.

The ifCouldWin-TradeRankWith actionList node type 427 shown in FIG. 30 is an example of a conditional action list node. It indicates that other users are suggesting ranking the current node (i.e., actionList's parent node) not because it is their favorite node of a given type but rather because it currently has enough ranking to give it considerable visibility. It indicates that they would rather be giving such a relatively high ranking to another node under the same parent indicated by the otherNodeUnderSameParent link428 if that node could rank higher in the action list than the current node. This type of action list item is useful for a group of users who wish to replace a first node which they support with a second node which they support even more, without increasing the chance that the first node will disappear from a high ranking before the second node has had a chance to reach an equal place within the ranking.

The insteadRankUnder actionList node type 429 shown in FIG. 30 suggests that the user remove any rank he has given to the current node (i.e., the actionList's parent node) under the current node's parent node in the current view, but that instead the user rank the current node under another parent node indicated by the otherParentNodePath link 430.

The alsoRankUnder actionList node type 433 shown in FIG. 30 suggests that the user also rank the current node under another parent heading, i.e., that indicated by the otherParentNodePath link 434.

The alsoSee actionList node type 435 shown in FIG. 30 suggests that in addition to any activity on the current node, the user see another node indicated by the otherNodePath link 436.

The insteadSee actionList node type 437 at FIG. 30 suggests that the user not waste time on the current node associated with the action list, but instead focus her or his attention on the node identified by the otherNodePath link 438.

The similarNode actionList node type 439 shown in FIG. 30 indicates that there is another similar node identified by the otherNodePath link 440 which he or she might find interesting.

The simVote actionList node type 441 shown in FIG. 30 suggests that the user might be interested in voting for a similar but somewhat different vote identified by the otherVote link 442.

Similarly, the relatedVote actionList node type 443 suggests that a user who might be interested in the current node for which the action list has been created might be interested in voting on a related but presumably different vote indicated by the otherVote link 444.

In all of these actionList node types, if the user clicks on the link to another node, he or she is given a view of the node referenced in that link. If the user clicks on the brief wording of the actual actionList sub-node itself, the system will either automatically take the action suggested or will generate a window to enable the user to take such action. After such action is taken the ranking associated with the given actionList sub-node will be increased to reflect that an additional person has found its suggestion worth following. In the case of action list items which merely suggest seeing another node or stating that another node is similar, clicking on their wording will merely increase their rank, since no additional action is associated with such action list sub-nodes other than that which can be activated by clicking on their associated link to another location within the database. In some embodiments of the invention, a user might be prevented from automatically taking an action relating to another location or another node in the database without at first at least clicking on the link which will take them to that other node or location so as to first see it. This will decrease the chance that people will take actions without at first at least taking some effort to see whether or not they think such actions are appropriate.

In other embodiments of the invention other types of actionList nodes could be used. For example, they need not have link to let a user see an alternate location in the database, nor link which will let a user select to make the suggested action, although such link are desirable. In other embodiments, actionList items are not placed under a separate actionList node, but instead are ranked someplace else, such as directly under the parent node to which their suggested action relates ranked along with most other user ranked nodes under that parent node.

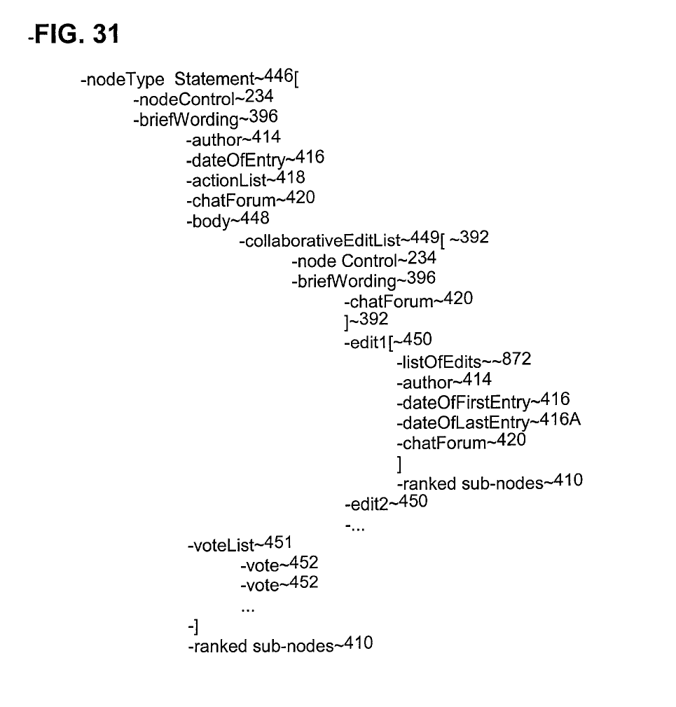

FIG. 31 illustrates the structure of a Statement node type 446. A statement node is similar to a heading node, as can be seen by comparing FIGS. 31 and 29, except for the fact that a statement node can include a body 448 and a vote 452. A statement node is intended to contain a statement within its briefWording 396 which can be voted upon. Its body 448 can include longer text or media to support or more clearly define the statement. In a portion of the database dedicated to discussing issues of importance, it is desired that users take considerable care when drafting the briefWordings 396 so as to concisely, accurately, and persuasively convey a significant point. If this is done, it is hoped that the best worded and most important statements will be ranked higher in views generated for groups of relatively intelligent users. In this way it is hoped that the best arguments for, against, and about major issues can be brought together in a rather compact form by viewing the brief wordings of statements under a given topic. However, because the brief wordings of statements will often need support or evidence, such support, evidence or explanation can be provided in a statement node's body, which can be a large multi-paged portion of text, including multi-media.

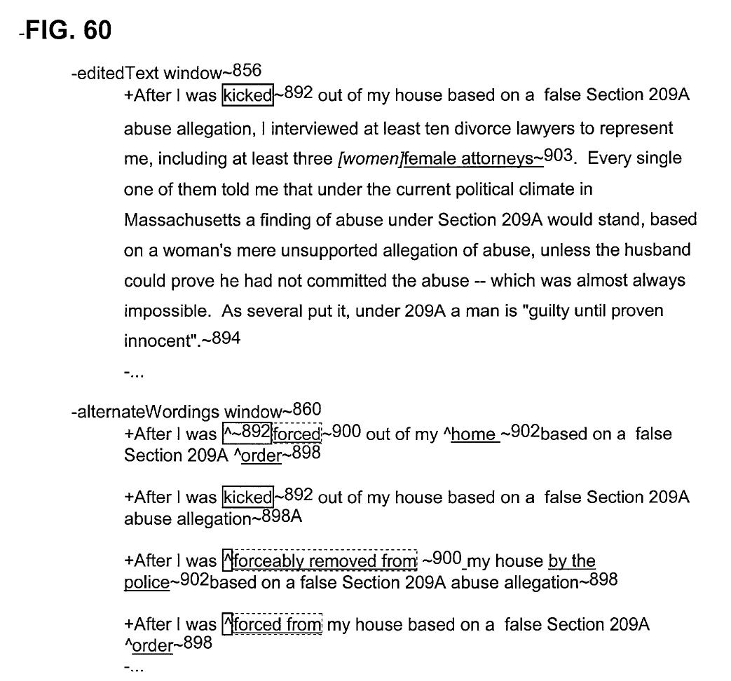

The body 448 of a statement can include underneath it a collaborativeEditList 449. A collaborative edit list is a node having a nodeControl 234 and a briefWording 396, which is preferably “collaborativeEditList” and having as a fixed sub-node a chatForum 420 under which users can enter chats about suggested edits for the body of a statement node. A collaborative edit list can include, as user-rankable sub-nodes, one or more edited versions of the body 450. FIGS. 60 through 62 illustrates portions of such edits. These edits are normally stored in a compact form, which only indicates the changes that have been suggested to the original body text or media. Each edit itself will be treated as a node that can be viewed in the collaborative editing list and will have under it its date of creation and its author.

The purpose of the edit list is to encourage the body of important statements to be edited so as to create the best possible statement of the case they are trying to make. By enabling multiple edits to be created for a given statement, a user can either choose to read such alternate statements or a group can get together and try to replace a given statement and its body with a new statement or body having improved wording suggested by such edits upon which a significant number of them agree.

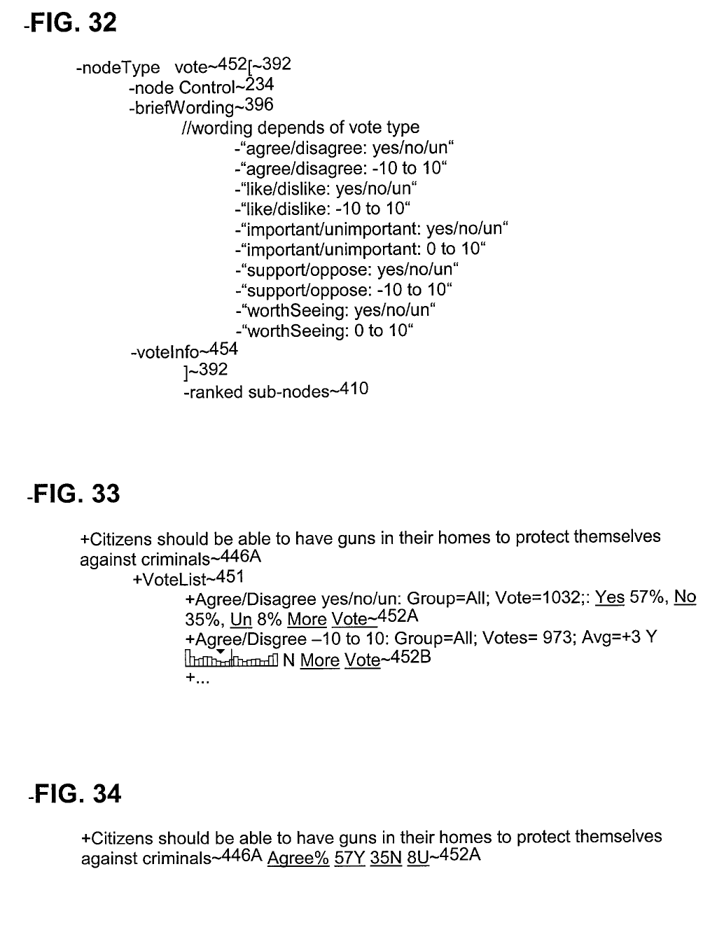

FIG. 32 illustrates a vote node type 452. As was described above with regard to FIG. 31, a statement can have associated with it a vote. So can many other types of nodes. A vote 452 has associated with it a node Control 234; a briefWording 396, which indicates the type of vote it is; and the votelnfo 454, which provides the current results of the vote for the group of the current view. The votelnfo 454 will also normally include controls or links which allow the user to change the group for which the vote results are shown, change the date range for which the vote result is shown, change the format of the vote view, and select all voters who have voted a certain way on the vote as a user group.

As shown in FIG. 32 a vote can have ranked sub-nodes 410 under it, although that feature may not often be used. As indicated above with regard to FIG. 31, a statement can have one or more votes associated with it under a voteList 451. Each such vote in a vote list can be a vote of a different type. Some of the more common vote types are indicated by the possible wordings listed under the briefWording node 396 in FIG. 32. In different types of statements users may feel different types of votes are most appropriate. Also different users may feel that one or more different types of votes are interesting because different types of votes reflect different feelings that one might have about a statement or issue. For example, a user may agree with a statement but feel that it is unimportant, in which case an agree vote alone would fail to capture important information. Similarly a user may agree with a statement but dislike it. Therefore users will be free to rank different types of votes in a voteList 451 associated with a statement. It will also be the case that certain types of statements or certain types of nodes will have fixed vote types associated with them.

FIGS. 33 through 36 provide some examples of how vote nodes can appear under different types of nodes with different types of projection.

In FIG. 33 two vote types 452A and 452B are shown under a statement 446A. The first vote type 452A is an Agree/Disagree: Yes/No/Undecided vote. The second vote type 452B is an Agree/Disagree: −10 To 10 vote. This latter vote includes a vote results graph 453, which displays the relative number of votes for each of the different degrees of agreement from −10 to 10. Such graphs provide a compact way of showing how the vote is distributed across such a range. In these two votes the number of voters, defined in the text which reads “vote=” followed by a number, are not the same because not all users who vote under one vote type will vote under the other.

FIG. 34 illustrates a compressed view of the voteList 451 shown in FIG. 33, which display can be selected by using the nodeTypeDisplay button 302 discussed above with regard to the view control window of FIG. 24. Such a compressed view enables users to obtain a more compressed view of a ranked list of statements and the vote make on them. In this case the user had selected to have the top ranked vote associated with each statement to be displayed in an abbreviated form attached at the end of the statement node to which it relates. This significantly increases the number of statements that can be displayed with voting information in a given number of lines.

FIG. 35 illustrates how different types of votes can display different information about a given statement. In the example of FIG. 35 it is assumed that the given group for which the view is generated generally agreed with the vote's associated statement but they found it an unpleasant aspect of reality.

FIG. 36 is an example of a vote occurring for a node under a heading for ranking various operas. In this case the vote is a WorthSeeing: 0 to 10 vote which is suitable for indicating whether or not users think a given item is worth seeing. In statements or articles in an argumentative forum, a person might think a node is worth seeing even if he or she disagrees with its content. For this reason, worthSeeing votes are often an important type of vote in addition to agreement/disagreement, or support/oppose types of votes.

As shown in FIGS. 33 through 36, most of the vote displays include links upon which users can click. These links allow one to take part in a given vote, to view the vote in more detail, or to see or select the voters who have taken a given position in a vote as a user group.

FIGS. 37 through 39 describe node types used to create and display threaded chat.

The chatForum node type 420 shown in FIG. 37 creates a heading under which chatThreadStart nodes can be entered. Like virtually all nodes, this node includes a nodeControl 234 and it includes a briefWording 396, which in the preferred embodiment is “chatForum”. A user is free to create and enter chatThreadStart node types under any chatForum node occurring in the database.

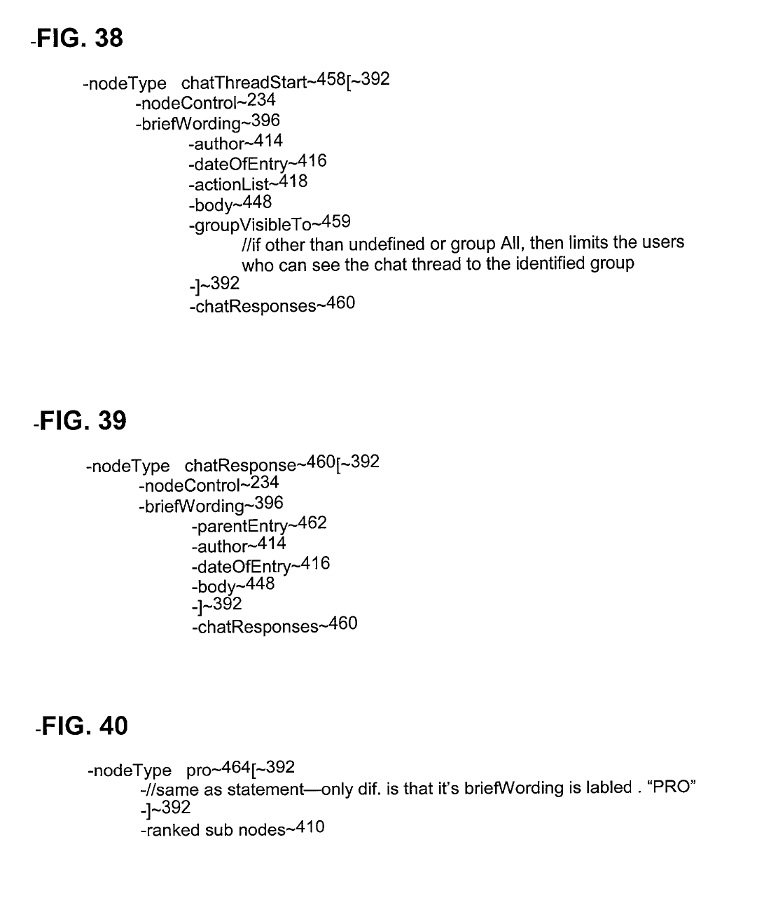

FIG. 38 illustrates a chatThreadStart node type 458. As can be seen from that figure, the chatThreadStart node is quite similar to the statement node type shown in FIG. 31, except that it doesn't include a collaborative edit list and it doesn't include a vote list. It is also different in that the only type of nodes intended to be placed under a chatThreadStart are chatResponse nodes. A chatThreadStart includes an actionList because, in the preferred embodiment of the invention, chatThreadStarts can be ordinally ranked by a given user under a given chatForum node and a user can even rank a given chatThreadStart under a different chatForum occurring under a different node. This is to allow users to, in effect, copy and order chat threads under what they feel are relevant locations within the hierarchical collaborative database of the system.

As shown in FIG. 39, a chatResponse node type 460 is similar to the chatThreadStart node type except for the fact that a chatResponse node has a parentEntry node 462 which identifies the chatThreadStart or chatResponse it has been generated in response to, and under which it should be shown in views. Also a chatResponse differs from a chatThreadStart in that it has no actionList, since in the preferred embodiment of the invention, a chatResponse cannot be ranked. from a Web page that he or she wishes to be verified. The quotelnContext field is a field into which the user can paste additional text including the intended quote if it is likely that the quoted text will occur more than one time in the Web page from which it has been copied. The occurrenceNumberlnContext list box is used to enable the user to indicate the number of the occurrence of the quoted text within the quotelnContext if it is a quote that is likely to occur more than one time within the quotelnContext.

If the user clicks the ok button 1012, step 1014 will cause steps 1016 through 1026 to be performed. Step 1016 uploads the VerifiedWebQuote command and the information from the controls 1004 through 1010 to the server. Then step 1018 causes the server to download to itself a copy of the Web page identified in the URLOfPage field. Then step 1020 verifies if the quote occurs in the page and is uniquely defined by the information uploaded in a manner similar to that described above with regard to the internalSelection function.

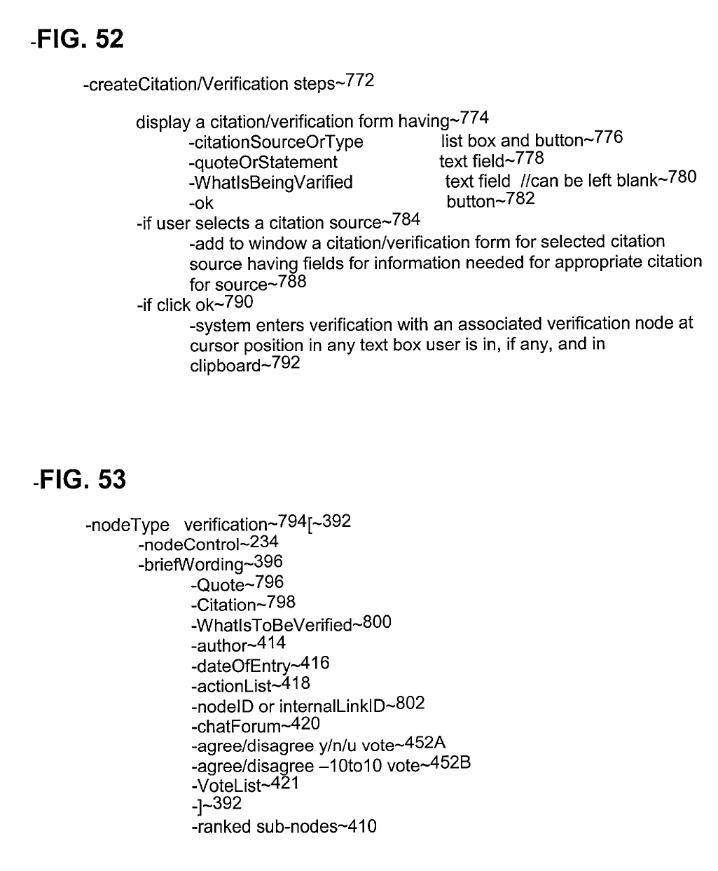

If the quote is uniquely identified in the page, step 1022 will cause steps 1023 through 1025 to be performed. In step 1023 the server automatically generates a citation verification for the Web page quote having a form similar to that described above with regard to FIGS. 52 through 54. Then step 1024 records a digital signature for that verification in the computer's database, so that if the verification is later altered, the system will be able to detect that fact. And then step 1025 causes the server to copy the verification to the user's clipboard on the server so that the user will then be free to insert it into the database as a node or as text contained within a node, or can even send it an internal or external emails to other users.

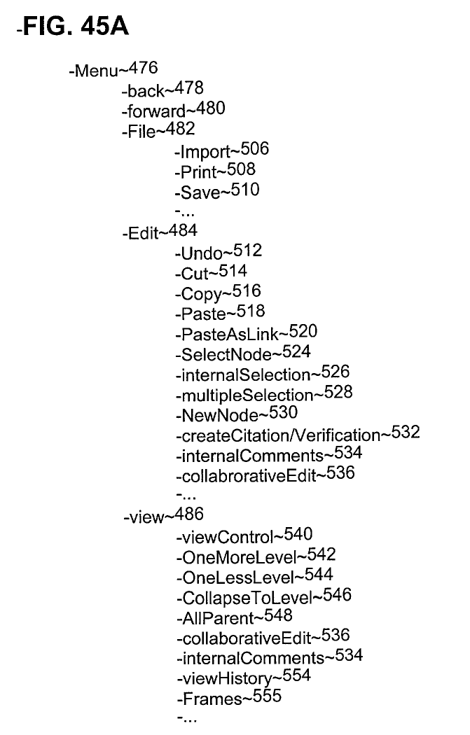

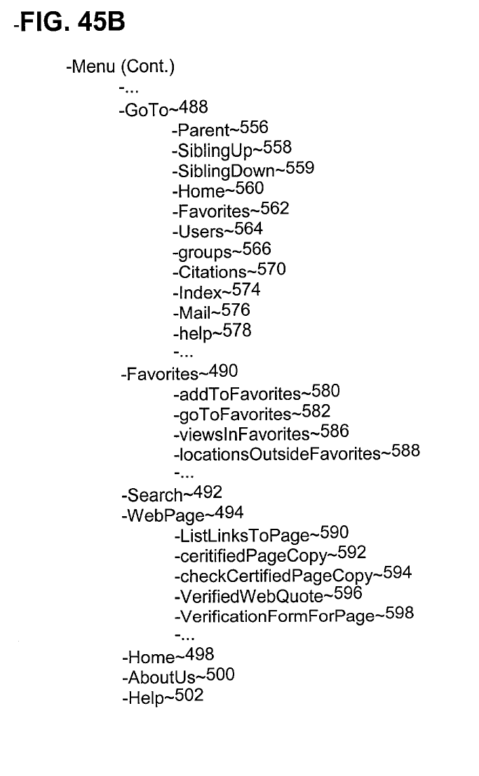

Returning to FIG. 45, if the user selects the WebPage menu's VerificationFormForPage option 598, a window will be displayed into which the user can cut or paste the URL of a selected page and then the server will automatically generate a verification form for that page having the URL, the common name for the portions of the database. In such a system the initial ranking of a node under a week heading could be automatically based on its user ranking under a day heading included in that week. A similar process could be used to calculate the initial ranking for nodes under month and year headings.

In other embodiments there could be node types for ranking and/or reviewing movies, books, magazine articles, vacation stops, hotels, restaurants, athletes, sport teams, performers, products, jokes, videos, or, as is indicated in FIG. 42, URLs to location on the Internet. In some embodiments, users could define new node types and collaboratively define the fixed nodes of node types. Even in embodiments in which special nodes types are not provided for ranking each such type of heading, more general types of headings could be used for the same purpose.

As is shown in FIG. 42, in the preferred embodiment, the URL nodeType is virtually identical to a statement nodeType. The difference being that the briefWording associated with a URL nodeType can be made to operate as a link to the URL and the node can include as a sub-node an actual hot link version of the URL text. The use of URLs nodes is valuable because it allows one to use the system to rank the relevance of URLs under collaboratively defined headings in a hierarchical database.

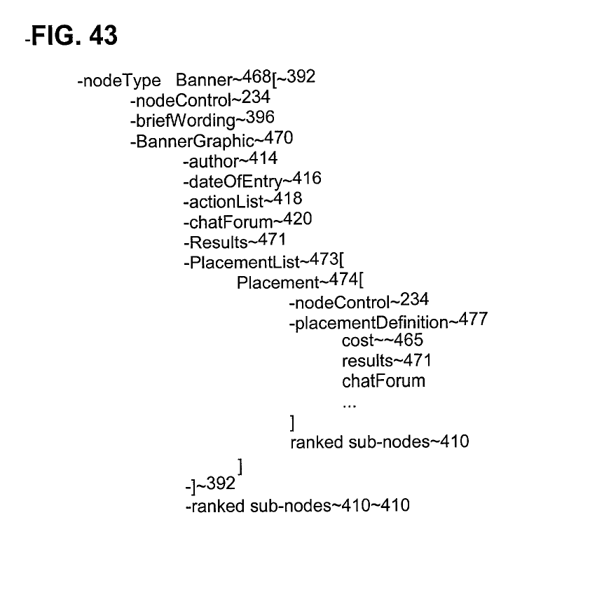

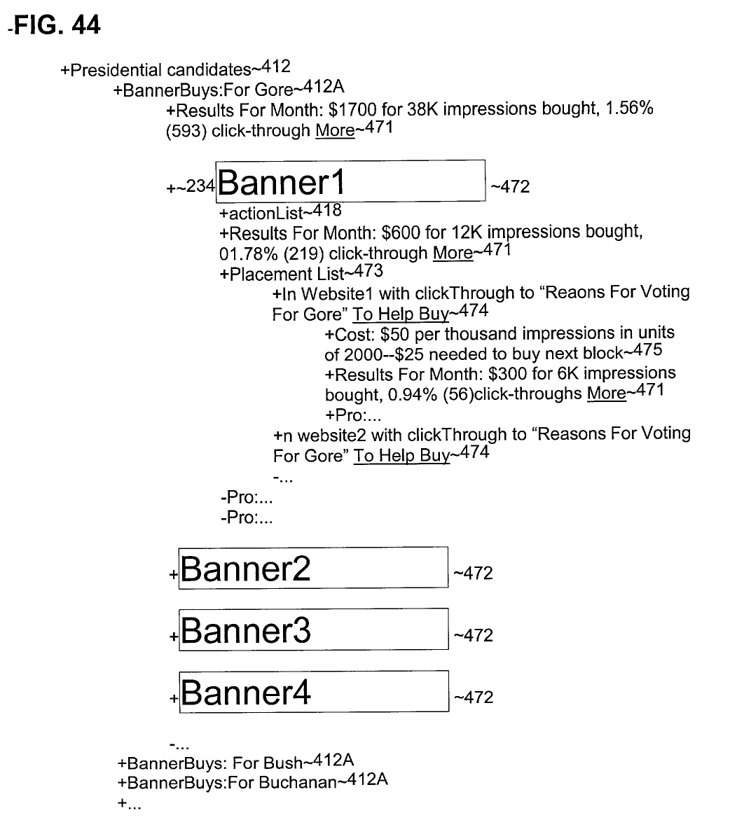

FIG. 43 describes a banner node type 468 which can be used to enable users to collaboratively place banner advertisements for subjects on interest to them. The Banner node type includes a nodeControl 234; an optional briefWording 396; and a BannerGraphic 470, which can include an image file and/or a GIF animation. Simplified representations of such banners are numbered 472 in FIG. 43. As fixed sub-nodes it includes an author node, a dateOfEntry node, and an actionList node, as do many other nodeTypes. In addition it includes a special results sub-node 471, which, as can be seen in FIG. 44, lists information about the amount of money that has been paid for banner placement, the number of banner impressions that have been bought, and the number of click-throughs that have been obtained as a result of such banner placements.

The banner node type also includes a PlacementList node 473, also shown in FIG. 44, which contains a list of one or more Placement nodes 474, each of which describes different types of buys which can be placed for a given banner. Each Placement node includes a nodeControl 234, and a placementDefinition 477, which in FIG. 44 corresponds to the text associated with the numeral 474. The placement definition defines such things as where the banner ad will be placed in the placement or through what service or contractual arrangement it will be placed, and the click-through target which defines, if a user clicks on the banner, where in the database the person clicking through on the banner will be brought. As is indicated in both FIGS. 43 and 44, a Placement sub-node 474 can include sub-nodes 465 and 471 for describing the costs associated with the placement and the results achieved for the placement.

Also users can place ranked sub-nodes under a banner node or under a placement node and can start threaded chat under each such type of node to allow discussion about what banners should be bought and what placements should be made for such banners.

The example of FIG. 44 shows another type of node, the BannerBuys node type 412A, which is similar to a normal heading node of the type described above with regard to FIG. 29 except that it includes a results sub-node 471 of the type described above with regard to FIG. 43 as one of its pre-defined sub-nodes.

As can be gathered from FIGS. 43 and 44, the purpose of the BannerBuys and Banner node types is to enable users to collaboratively enter and rank and place purchases for the placement of advertising to promote various views of interest to them. This basic concept need not be limited to banner ads but could be used for other types of advertisements including TV, radio, and print advertisements. The intent is that this will make the marketplace for political and social commercial expression more liquid and participatory.

FIG. 45 illustrates a possible menu structure that can be used with the invention to provide access to some of the many functions that can be used in association with it. It should be understood that in other embodiments of the invention these and other functions could be accessed in very different ways using very different hierarchical, or even a non-hierarchical command structure. In some embodiments such menu items would mere by links that would upload commands to a server instructing it to take a given action for the client. In other embodiments more of the responses to such menu items could be executed on software running on the client itself.

The Menu 476 of FIG. 45 includes as top level child menu items a Back item 478, a Forward item 480, a File item 482, and Edit item 484, a View item 486, a GoTo item 488, a Favorites item 490, a Search item 492, a WebPage item 494, a FrameControl item 496, a Home item 498, an AboutUs item 500, and a Help item 502.

The back and forward items 478 and 480 correspond to the back and forward buttons available on most web browsers. They allow a user to move backward and then forward among successive views which have been generated in the given in his browser of the database.

The File menu heading 482 includes an Import item 506, which allows a user to import files of text, graphics, sound, or video when he is in a mode that allows him to create new content in the database.

The Print menu item 508 allows the user to print a selected page or a selected sub-portion of a page that is currently being viewed.

The Save menu item 510 under the File item 482 allows a user to save a current page to disc.

The top level Edit menu item 484 shown in FIG. 45 includes the following sub-menu options: Undo 512, Cut 514, Copy 516, Paste 518, PasteAsLink 520, SelectAll 522, SelectNode 524, InternalSelection 526, multipleSelection 528, NewNode 530, createCitationNerification 532, internalComments 534, and collaborativeEdit 536.

The Undo option 512 allows the user to undo many prior commands such as the Cut, Copy, Paste and PasteAsLink commands, listed below under the menu item.

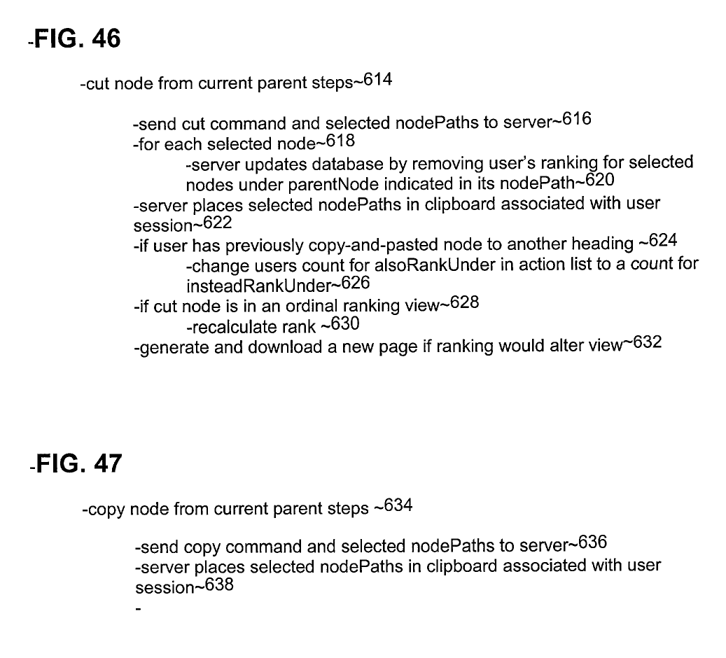

The Cut option 514 under the Edit menu enables a user to cut a selection. If a user is in a text editing mode, this operates in the way that cut normally operates in a text editor. If a node is selected when the user selects the cut command, the instructions 614, shown in FIG. 46, will be executed, which will cut the one or more currently selected nodes from their current respective one or more headings in the views in which they were selected.

In this case, when the cut option 514 is selected in the Edit menu, a step 616 will be performed, shown in FIG. 46, which will send the cut command and any currently selected node paths to the server computer. Each such node path is a hierarchical path from the selected node up to the root node in the view in which the node has been selected.

Next a loop 618 causes a step 620 to be performed for each of the selected nodes that have been uploaded to the server. Step 620 updates the database in the server by removing any ranking that the user who has issued the cut command has made for the selected node under the parent node indicated in the associated node path that has been uploaded to the server.

Once this has been done for each of the selected nodes, step 622 places the selected node paths in a clipboard associated with the user's communication session with the server.

Next a step 624 tests to see if the user has previously copied-and-pasted the nodes represented by any of the node paths to any other heading. If so, for each such node, a step 626 is performed which changes the user count for the alsoRankUnder actionList sub-node 433, of the type described above with regard to FIG. 30, in the actionList associated with the Parent node from which the given node has been cut and increases the count associated with the insteadRankUnder actionList sub-node type 429, described above with regard to FIG. 30, so as to automatically update the action list of the parent node from which the node being cut has been removed by the user to reflect such action.

Next step 628 tests to see if the user who has made the cut is in a view that orders nodes under parents by the user ordinal ranking, and, if so, it recalculates the rank in step 630.

Next in step 632 the server generates and downloads a new page, if any ranking change made by the command would alter the user's view.

Returning now to the menu of FIG. 45, if the user selects the Copy option under the Edit menu item shown in that figure, contents of the current selection will be copied to clipboard. If the user is in an edit box, and the contents of the clipboard is a text string this will be a normally text editor copy, except that it is being done in a client server context.

If, on the other hand, the contents of the clipboard are one or more nodes, the steps 634 of FIG. 47 will be performed. These include a step 636, which sends the server the copy of the copy command and the nodePaths of any currently selected nodes to the server, and a step 638 which places those uploaded nodePaths in the clipboard which the server associates with the current user's user session.

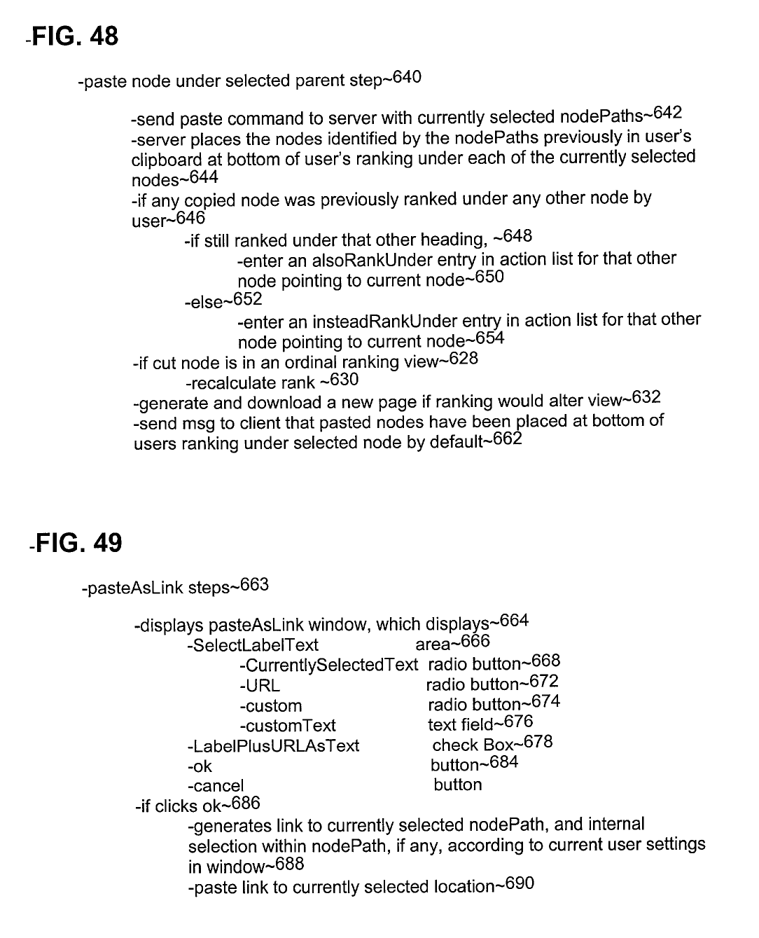

Returning to FIG. 45, if the user selects the Paste option 518 under Edit Menu 484 of that figure, and the user is in an edit mode and the contents of the clipboard are a text string, a normal text editor paste will be performed. If, on the other hand, the current selection and contents of the clipboard are both database nodes the instructions 640 shown in FIG. 48 will be executed.

As shown in FIG. 48, if this occurs, a step 642 will send the paste command to the server with the one or more nodePaths associated with the one or more currently selected nodes. It should be noted that some embodiments might limit the number of nodes to which a paste command can paste one or more nodes to a single node, so as to prevent people from making massive copies. Others embodiments, however, may limit it to a relatively small number of nodes at one time such as 10, because there will be times when a user will want to copy a given node to a location under multiple other nodes.

Next a step 644 places the nodes identified by the one or more nodePaths currently stored in the user's clipboard on the server at the bottom of the user's ranked nodes under each of the currently selected nodes. This is done by creating a UserAction 175 of the type shown in FIG. 5, which has a RankingActionRecord 194 identifying the ParentNodeID 195 of each new parent node under which a node in the clipboard is to be ranked.

Next a step 646 tests to see if the user previously ranked any of the pasted nodes under another node. If so a step 648 tests to see if the copied node is still ranked under that other heading. If so step 650 create, or increment the ranking of, an alsoRankUnder entry 433, of the type shown in FIG. 30, in the action list for the pasted node under such other parent node identifying the new parent node under which the pasted node has just been ranked. If the test of step 648 is negative, step 652 causes step 654 to be performed. This step will create, or increase the ranking of, an insteadRankUnder entry 429, of the type shown in FIG. 30, under any other parent node in which that pasted node has previously been ranked by the same user.

The preferred embodiment will similarly automatically update other ActionList sub-node when it can do so from tracking the action of users.

Next steps 628 and 630, which correspond to the similarly numbered steps in FIG. 46, detect whether or not the user's current page view has nodes which have ordered based upon user ordinal ranking and, if so, it recalculates the rank in step 630. Then step 632 generates and downloads a new page if the ranking would alter the user's view. Next a step 662 sends a message to the client informing him that the pasted nodes have been placed at the bottom of the user's ranking under the parent nodes to which they have been pasted and suggesting that she or he re-rank them if it is desired that that they have other user ranking under those new parent headings.

Returning to FIG. 45, if the user selects the PasteAsLink option 520 under the Edit Menu 484, the instruction 633 shown in FIG. 49 will be executed.

FIG. 49 shows that if this is done, a step 664 will display a PasteAsLink window, which includes the controls 666 through 684.

The SelectedLabelText area 666 includes three radio buttons 668 through 674, which enable a user to select the text that will be used as a link to the currently selected node or text in user's clipboard that is to be pasted as a link. If the user selects the CurrentlySelectedText radio button 668, the selected text in the user's clipboard will become the link. If a node has been selected the title or briefWording of the node will become the text associated with the link. Of course this selection is only appropriate where it will generate a relatively brief text to use as a label for the link. If the user selects the URL radio button, the URL for a link to the CurrentlySelectedText in the user's clipboard will be used as a label. This URL will include the main name for the server, an internal path for the node in which the selection occurs, and, if the selection is a sub-portion of a node, an identifier for that sub-portion. If the user selects the custom radio button 674 then the text entered into a customText text field 676 will be used as the label for the link.

The PasteAsLink window's LabelPlusURLAsText check box 678, if checked will cause whatever text is selected by one of the radio buttons 668 through 674 plus the URL of the selected node to become the label associated with the link.

If the user clicks the ok button 684 step 686 will generate a string which represents the URL pointing to the currently selected nodePath and the internalSelection within that nodepath, if any, according to the current user settings in the controls described in the immediately preceding paragraphs. Then step 690 will insert the link defined by the PasteAsLink window to the current location, which if the user is currently in a text edit mode will be at the current cursor location. If the user is not in such a text editor, the link will be pasted as a child at the bottom of the user's ranking under the currently selected node, if any.

The ability to generate such internal links is important because it enables one to create cross-references within the database and within both internal and external email sent concerning data in the system.

Returning to FIG. 45, if the user selects the SelectNode option 524 in the Edit Menu 484, the system will cause the last node in which the user has taken any action to be selected. It should be appreciated that a user can also select a node by using the select/unselect toggle 248 contained in the node control window described above with regard to FIG. 19. A node selection causes information to be uploaded to the server informing it that a node has been selected and containing the ID of that node.

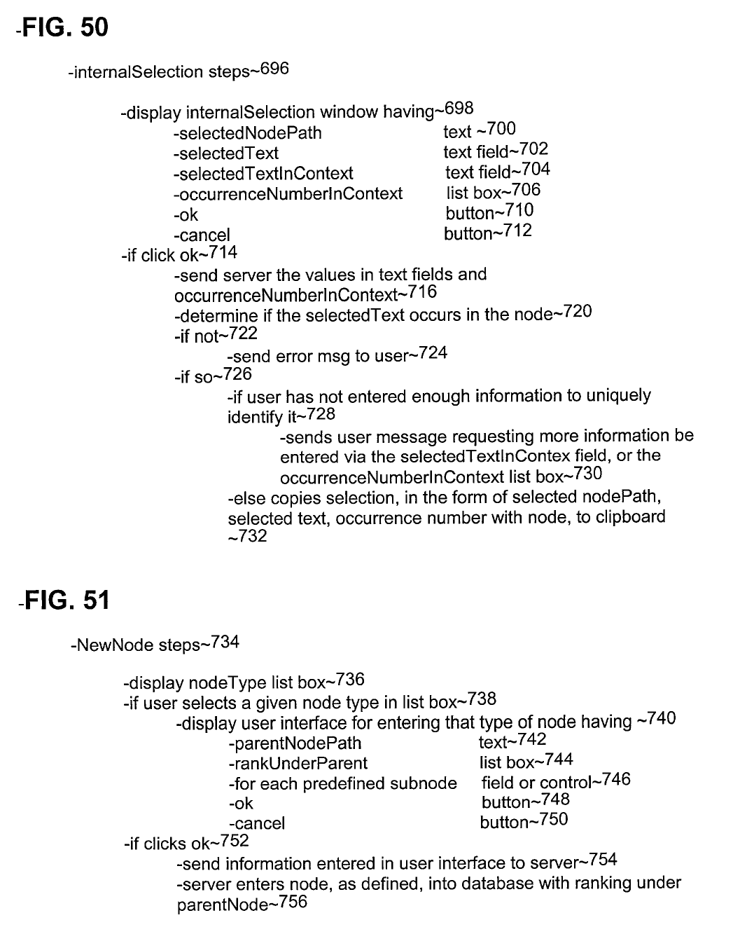

If the user selects the internalSelection option 526 under the Edit Menu of FIG. 45, the internalSelection steps 696 shown in FIG. 50 will be executed to allow the user to select a portion of a node's text.

FIG. 50's instructions are designed for use with a client browser which does not have the capability of allowing a user to identify to a server a user selected portion of text within a web page, the way one can easily selected a portion of text within the text editors of most personal computer applications. As a result the instructions shown in FIG. 50 contain steps and user interface to help perform this function.

When the user selects to make an internalSelection, step 698 displays an internalSelection window having the item shown in FIG. 50.

This window includes a selectedNode text display 700, which displays the path of the currently selected node for the purpose of allowing the user to verify that the currently selected node is the node in which he or she wishes to make the internal selection.

The internalSelection window also includes a selectedText text field 702. This is an editable field into which a user can type of paste the text which he wishes to be the internal selections. Since most browsers let a user select text in a displayed web page by dragging a mouse cursor across it, and then to copy the paste using the Edit>Copy selection in the browser's menu, it is quite easy for a user to copy-and-paste a desired selection into this field.

The internalSelection window 698 also includes a selectedTextInContext window 704 into which the user can cut and paste a larger subsection of text including the selectedText shown in the text field 702 in context. This is not necessary, but is recommended if the selectedText in the text box 702 is likely to occur multiple times within the given node.

The internalSelection window also includes an occurrenceNumberInContext list box 704, which allows the user to list the number of the occurrence of the selected text shown in the field 702 within the larger body of text shown in 704. This might be very useful if the user is desirous of selecting a very common word or piece of text such as a period or a comma that occurs multiple times within a body of text large enough to be likely to be unique within the selected node.

If the user clicks the ok button 710 in the internalSelection window of FIG. 50, step 714 causes the steps indented under it to be performed. These include a step 716 which sends the server information that the user desires to make an internal selection and includes with it all the values indicated in the controls of the internalSelection window.

Next the server performs a step 720, which determines if the selectedText occurs in the selected node. If not step 722 causes the server to send an error message to the user in a step 724. If so, step 726 causes step 728 through 732 to be performed.

Step 728 tests to see if the user has not entered enough information to uniquely identify the selectedText within the selected node. If not, the server in step 730 sends the user a message requesting that more information be entered defining the selection via the selectedTextInContext field or the occurrenceNumberInContext list box. If, one the other hand, the test of step 728 finds the user has entered enough information to uniquely identify the selectedText within the selected node, step 732 copies the internal selection in the clipboard it maintains for the user, including the selected node's path within the current view, the selectedText, and its occurenceNumber within the node. Returning to FIG. 45, if the user selects the multipleSelection item 528 in the Edit Menu, a message will be sent to the server indicating that the user would like to toggle from a single selection to a multipleSelection node and preferably indication of the resulting current state will be displayed on the client's user interface so the user will be aware of this state. In addition each time the user makes a selection while in the multiple Selection mode there is feedback to the user informing him or her that the last selection was a cumulative selection.

If the user selects the NewNode option 530 under the Edit Menu, the NewNode instructions 734 shown in FIG. 51 will be executed.

FIG. 51 shows that if this is the case, a step 736 will display nodeType list box 736 on the browser screen enabling the user to select from different node types, such as headings, statements, pro statements, con statements, etc., of the type described above. If the user selects a given node type steps 738 and 740 will display a user interface for creating a node of that type. This interface will include a text 742 identifying the parent node under which the new node will be entered, which will be the currently selected node or the last node in which the user has taken an action. If this parent node is incorrect, the user can cancel out of the NewNode window and select the desired node before again selecting to create a new node. In other embodiments of the invention, a hierarchical list box could be provided in which the user could select the parent node under which the new node is to be created if it is not the desired node.

The interface for creating a new node includes a rankUnderParent list box 744, which lets the user specify the user rank that he wishes to give to the new node being created under the current parent node. In addition the interface includes for each predefined fixed sub-node of the node type of the node being created a field or control for entering or defining that field if it is not an automatically created field.

If the user clicks the ok button 748 shown in FIG. 51, step 752 will cause step 754 and 756 to be performed. Step 754 sends the information that the user has entered to the server. Then in step 756 the server enters the node as defined into its database with the user-defined ranking under the parent node.

Returning to FIG. 45, if the user selects the createCitation/Verification item 532 under the Edit Menu, the createCitation/Verification steps 772 shown in FIG. 52 will be performed.

FIG. 52 shows that if this is the case, step 774 will display a citation/verification form window, which has a citationSourceOrType list box and associated button 776, a quoteOrStatement text field 778, a WhatIsBeingVerified text field 780, and an ok button 782.

The sources or source type which can be selected in the list box 776 include named sources of authorities such as well-known magazines, newspapers, Law Reporters, and web sites. It also includes types of citations such as periodicals, books, or web sites. As is indicated at step 784, if the user selects a citation source, step 786 adds a window to the citation/verification form for the selected citation source having filled in fields for any information inherent in the selection and provided fields for any additional information needed for an appropriate citation for the selected source or source type.

As shown in step 790, if the user clicks the ok button 782, step 792 causes the system to enter a verification at the current cursor position in any text box which the user is editing by the system, or if the user is not currently in such a text box in the server's clipboard for the user.

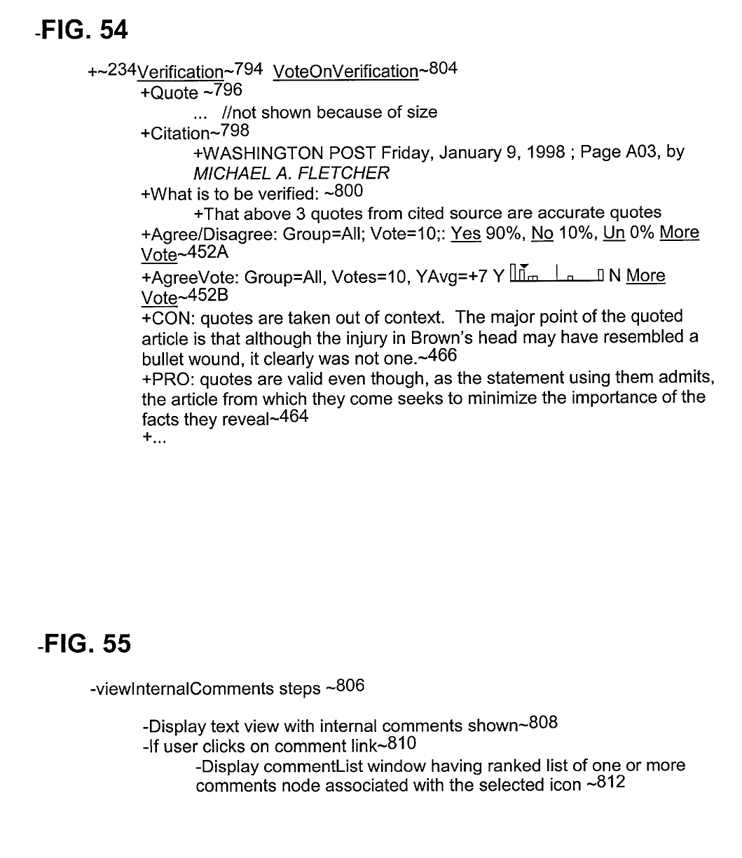

FIG. 53 illustrates the components of a verification node of the type that will be created by step 792. Each such verification node 794 includes a nodeControl 234, as is shown in FIG. 54 and a briefWording, in this case normally the word “verification” 396.

Each verification node includes as sub-nodes a Quote, Citation, and WhatisToBeVerified sub-node 796, 798, and 800. The Quote and WhatisToBeVerified sub-nodes correspond, respectively, to the text in the quoteOrStatement text field 788 and the WhatIsBeingVerified text fields 782 shown in FIG. 52. The citation 798, if any, corresponds to the citation, if any, created if the user selects a citation source and fills out its corresponding citation window as is described above with regard to steps 784 and 788 of FIG. 52.

The verification also includes author, dateOfEntry, and actionList sub-nodes of the type described above, as well as a nodeID or internalLinklD 802, which contains a link to the location in the database in which the verification has been placed by a user. For example, in FIG. 25 a verification 794 is shown having been placed at the end of a three-part quote from a newspaper article, which is included in the body of a given node. In such a case, the node 802 of the verification would be an internalLinklD pointing to the exact location within the body of the given statement in which the verification occurs. The verification node also includes an Agree/Disagree: Yes/No/Undecided 452A and an Agree/Disagree: 0 To 10 vote 452B, as well as a voteList 421 under which a user can add other votes if desired.

FIG. 54 provides an example of an expanded view of the verification shown at the bottom of FIG. 25. As is indicated by both FIGS. 25 and 55 the purpose of a verification is to indicate whether or not a given quotation or other assertion is true. In some embodiments of the invention, if a user selects to add his weight for or against a verification such as by clicking on the link 804 shown in FIG. 54 the user will be notified that making a false verification can result in sanctions, such as fines or loss of rights within the system. In some embodiments in the invention, only certain users will be qualified to make verifications, so as to prevent users who are seeking to misuse the system from entering inaccurate verification votes.

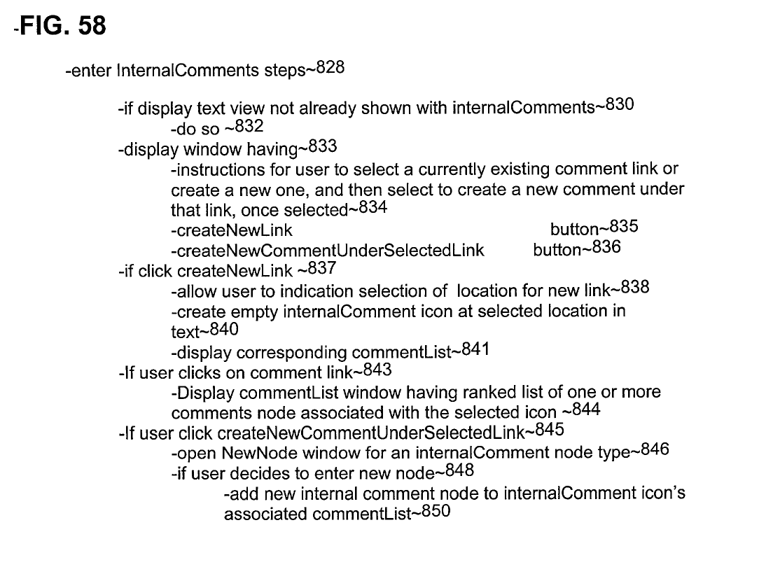

Returning to FIG. 45, if the user selects the internalComments option 534 from under the Edit Menu, the steps 828 of FIG. 58 will be executed.

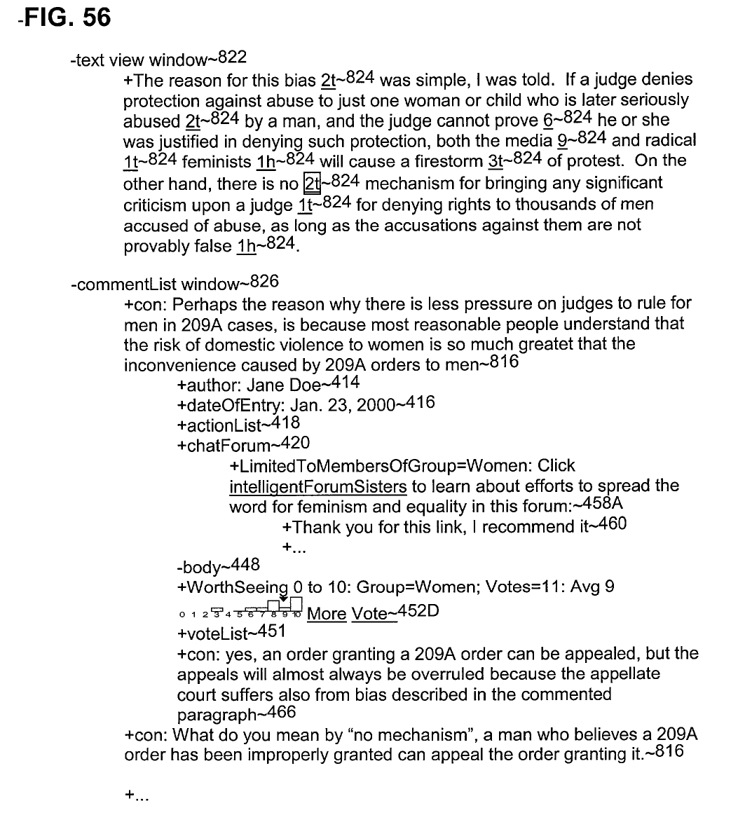

FIG. 58 indicates that if the user selects to enter an new internal comment, step 830 will test to see if the text of the current view is shown with internalComments, and, if not, step 832 will display the text with comment links 824, as is shown in the text view window 822 of FIG. 56.

Each comment link 824 indicates that one or more internalComments are associated with its position in the text. In the embodiment shown in FIG. 56, comment links contain a numeral which can be followed by a “t” for ten, “h” for hundred, “k” for thousand “tk” for ten thousand, etc. to indicate the number of comments associated with the link, represented as a power of ten multiplied by the numeral. Although not shown the comment link should be a conspicuously different color and/or typeface than the main text so a user can more easily separate them out from the main text.

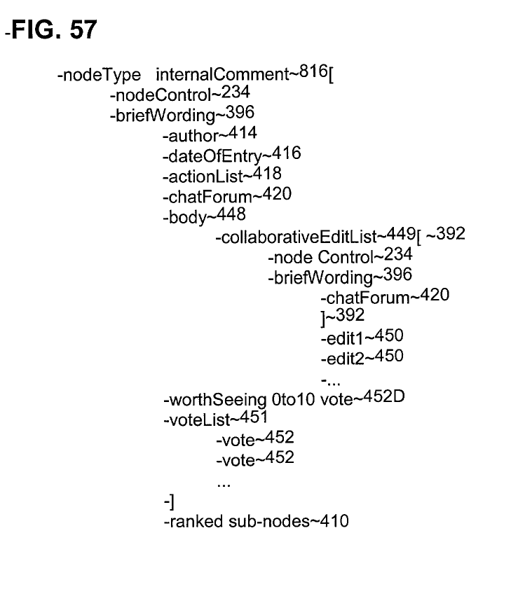

FIG. 57 describes the structure of an internalComment node 816 of the type which are associated with the comment icons 824 shown in FIG. 56. Each such internalComment is basically identical to a statement node except that it has as a fixed node a worthseeing: 0 To 10 Vote 452D, although a user is able to add other types of votes to its voteList 451 as with normal statements. The inclusion of a fixed worthseeing 0 to 10 vote 452 is included in internalComments because the sum of such votes over the all users in the current view group will be the criteria for ranking comments in a commentList window, unless a user selects otherwise.

In some embodiments, other types of links and comment nodes can be used for comments. Also it should be understood that similar types of commenting could be performed in other types of media such as video, audio, or external Web pages.

Returning to FIG. 58, once step 830 and, if necessary, step 832 have been performed, step 833 will display a window instructing to select a currently existing comment link or to create a new one and then to select to create a new comment under that selected link.

As in indicated by step 843 of FIG. 58, if the user clicks on one of the comment links, or icons, 824 shown in FIG. 56, a step 844 will display a commentList window 826, shown in FIG. 56, having a ranked list of the one or more comment nodes associated with the selected icon. It will be in the currently displayed comment list that a new comment can be entered.

If there is no comment link in the portion of text where a user desires to place a comment, the user can clicks on the createNewLink button 835 shown in FIG. 58. If this is done, a step 837 will cause steps 838 through 842 to be performed.

Step 838 allows a user to select the location for a new link. On a browser having the capability similar to described above with regard to the internal selection function of FIG. 50, an interface similar to that described with regard to that figure will be used to allow the user to define a location within text at which the new internalComment icon is to be located. The only difference being that that interface used in step 838 should allow the user to indicate whether the insert is to be located before or after the text selection defined by that interface.

Once the user has indicated in step 838 where the new internalComment icon is to be located, step 840 will insert a new internalComment link or icon 824 of the type shown in FIG. 56 into the text at that location, and step 841 will create and display a commentList window 826 like that shown in FIG. 56 except that it will be empty since no comments have yet been entered under the new internalComment link 824 just created.

Once either a commentList for a desired comment has been displayed, either in response to steps 843 and 844, in response to steps 837 through 841, or if such a comment list has been previously displayed in response to the Steps of FIG. 55, which are described below, the user will be able to create a new comment by clicking on the createNewCommentUnderSelectedLink button 836 shown in FIG. 58. If this is done, step 845 of FIG. 58 will be cause steps 846 through 850 to be performed.

Step 846 will open a new node window for the creation of an internal comment node type. Then after a user has had a chance to fill out the form associated with the creation of such a node type, if the user clicks on an enter button, a step 848 will cause step 850 to add the new internal comment node to the currently displayed comment list.

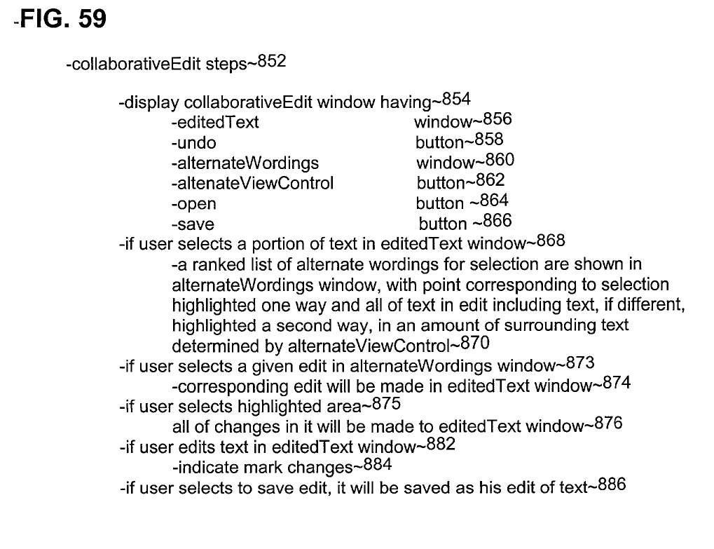

Returning again to FIG. 45, if the user selects the collaborativeEdit option 536 under the Edit Menu, the collaborativeEdit steps 452 shown in FIG. 59 will be performed.

The major purpose of these functions is to allow edits 450 of the type shown in FIG. 31 to be created under the collaborativeEditList 499 associated with the body of a node, such as a statement. Normally the best time to use collaborative editing is early in the life cycle of a new node being proposed by one or more people. This is because at such a time it is relatively easy to get as much support for a replacement node having edited wording as it is for the original node it is intended to replace, since usually at this time the prior node will not already have that many rankings or votes. Later, once a node has become a major node in terms of its ranking under a heading, replacing it with a better worded node tends to become more difficult. The use of actionLists, chatForums, and email can help in organizing support for a new, better-worded version of a node having a high rank. Another way to encourage wording to be updated is to cause the standard view of the outline to be one that only takes into account votes that have been taken within some relatively recent period of time, such as within the last year. This, particularly in conjunction with the actionList sub-node type ifCouldWin-TradeRankWith 427 shown in FIG. 30 would make it increasingly possible for newer versions of nodes to replace the highest ranking nodes under given parent nodes over time.

The embodiment described in FIG. 59 assumes a Java applet, or some other type of code running on the client computer to give the browser more intelligence when displaying the collaborativeEdit window. However those skilled in the art of Web-based applications would understand that all the functionality described below could be achieved with more primitive browsers that do not support such applets, although such interfaces would tend to be slower to use (at least until Internet latencies drop substantially over their current level).

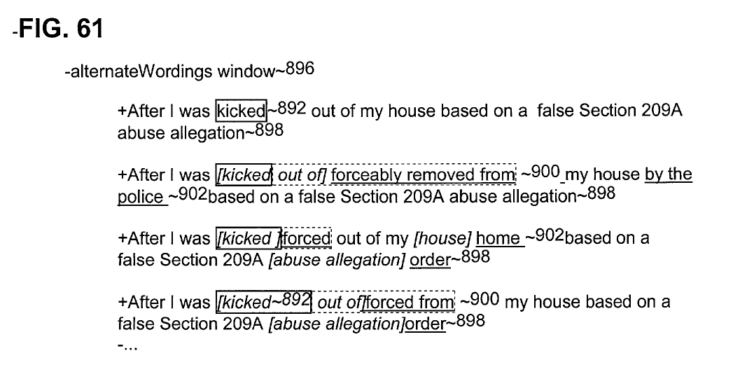

FIG. 59 shows that when the user selects to perform collaborative editing, step 854 displays a collaborativeEdit window. This window includes an editedText window 856 of the type shown in FIG. 60, in which the text being edited is shown. The collaborativeEdit window includes an undo button 858, which allows a user to undo an edit that he or she has made to the edited text. It includes an alternatewording window 860 shown in FIG. 60, which displays alternate wordings that have been made in previous edits for the text, if any, that correspond to a selected portion of the edited text. The collaborativeEdit window also includes an alternateViewControl button 862, which controls the view within the alternatewordings windows, including the amount of surrounded text which each alternate wording shown in the window has around the portion of its text which corresponds to the selected text in the edit window and which controls whether or not the portion of text 892 shown in the edit window as shown in FIG. 60 is represented by a caret in the alternatewording window as it is in FIG. 60 or is shown in full as is shown in the alternatewording window of FIG. 61. Finally the collaborativeEdit window includes open and save buttons 864 and 866, which let the user save an edit of a given node's text that he is working upon and then later open it for continued editing or modification.

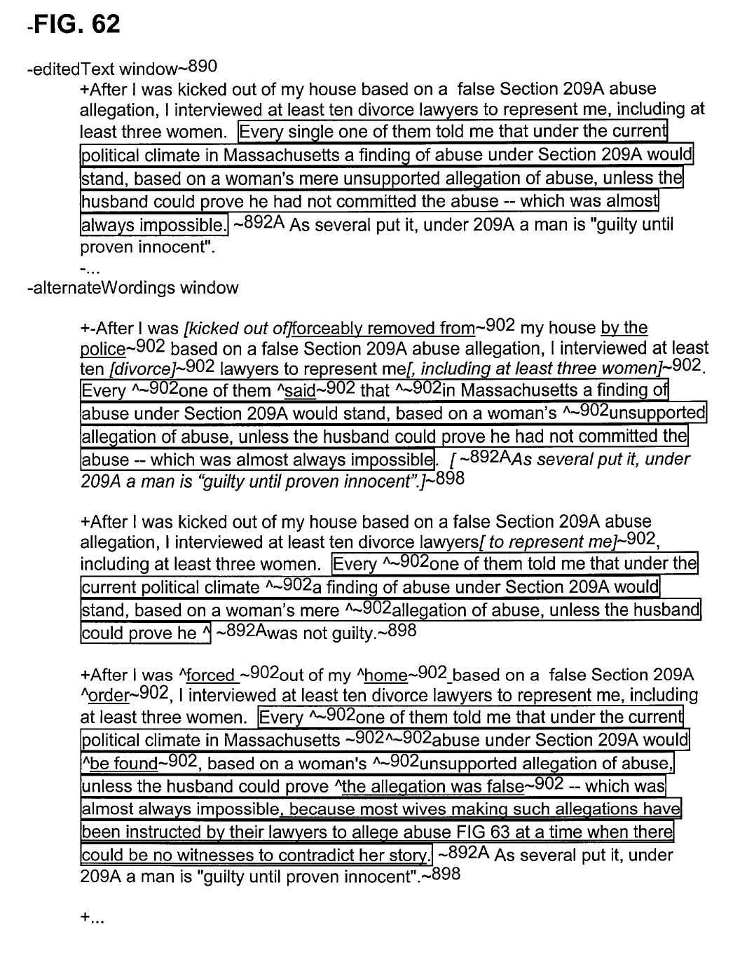

If the user selects a portion of text in the edit window, such as the portion 892 shown in FIG. 60, step 870 of FIG. 59 will display a ranked list of alternate wordings in the alternatewordings window 860, as is shown in FIGS. 60 and 61. In this display the point corresponding to the selection in the editedText window will be highlighted in a first way indicated in FIGS. 60 and 61 by a solid border and any additional text included in a single edit including the selected text will be highlighted a second way, as is indicated by the dotted border 900 in FIGS. 60 and 61. The selection in the edit window can be for a word, a group of words, a line, a selection, a paragraph, or an entire text. For example, in FIG. 60 the selection 892 is a single word, whereas in FIG. 62 the selection 892A is a sentence.

As indicated in FIG. 31, each edit 450 includes not only a list of edits corresponding to the marked changes shown in the alternateWord window 860 shown in FIGS. 60, 61 and 62, but also an author node 414, a dateOfFirstEntry node 416, a dateOfLastEntry node 416A, and a chatForum under which users can place comments about the current edit.

In the preferred embodiment, the alternate wordings shown for a given selection in the alternateWording window are ranked in terms of the number of edits which include identical changes to the text shown highlighted in the second way in each alternate wording, i.e., identical changes in their portion of text corresponding to the selected text in the editedtext window. If the surrounding text shown for an alternate wording differs in different edits which are identical with regard to such a highlighted portion then the most popular version of such surrounding text, i.e., that which has been ranked the highest or which has had all of its changes selected by more people will be shown.

For example if the user selects a single word in the editedText window, the alternate wordings shown in the alternatewording window are ranked in terms of the number of edits which a given change which corresponds to that selected word, with the surrounding text shown for that edit having the most other edits which match all of its other changes. In many cases there will be so few edits that all of the alternates and all of the surrounding text of any one alternate will have the same rank, in which case ranking can be performed based on another criteria selected in the alternateViewControl, such in terms a coming from an edit which has the greatest number of its changes selected in other edits, or a much more simple criteria such a recency.

For a second example, if the user selects a paragraph the alternate wordings shown in the alternatewording window would correspond to full paragraphs, and alternate wordings would be ranked on the number of edits including each full paragraph. A secondary criteria would be to rank paragraphs in terms of the number of their changes that have been selected in other edits.

If a user selects a given change 902 in the alternateWording window, steps 873 and 874 of FIG. 59 will cause the corresponding change to be made in the editedText window 874. If the user selects a highlighted area such as the areas 892 or 900 in the alternateWording window shown in FIGS. 60, 61 and 62 steps 875 and 876 will cause all the changes in that selection to be made to the editedText window.

If the user makes changes to text in the editedText window, step 882 will mark the corresponding changes, as is indicated by the numeral 903 in FIG. 60, in the editedText window. If the user is satisfied with a given edit, or portion of an edit, he or she can then click the save button 866 shown in FIG. 59 to save his edit and cause it or any of its updates to be added to the his or her edit entry 450, shown in FIG. 31, for the current body of text.

In some embodiments of the invention, virtually any form of collaborative editing which is currently or hereafter know could be used with the collaborative ranked database of the invention.

Returning now to FIG. 45, the viewControl Menu item 486 includes a plurality of options for allowing the user to control her views of the outline.

Perhaps the most important of these is the viewControl 540 which will evoke the viewControl window described above with regard to FIG. 24 for the parent node of the current view.

The view Menu also includes a OneMoreLevel option 542 and a OneLessLevel option 544, which allow the user to expand or contract the level of outline expansion in the current view.

The CollapseToLevel option 546 will cause the current view to collapse to the level of expansion of the currently selected node, if any.

The AllParent paths option 548 will generate a view showing all of the parent nodes under which the currently selected node has been ranked, ordered by default in terms of the amount of activity the current node has had under each of those alternate parent nodes. The view preferably also has controls to allow the user to select other methods for ranking the list of the current node's parents. Each such parent listing should either be or have associated with it a link enabling the user to jump a view of that parent node shown in the context of the highest ranking path for that parent node in the system's standard view.

The collaborativeEdit view option under the view Menu in FIG. 45 is equivalent to the collaborativeEdit entry 536 under the Edit Menu, which has just been described to FIGS. 59 through 62.

The internalComments option 534 under the view Menu of FIG. 45 will cause the viewlinternalComments instructions 806 shown in FIG. 55 to be performed. This includes a step 808 which causes text to be shown with internal comments, as described above with regard to step 832 of FIG. 58, and steps 810 and 812, corresponding to steps 843 and 844 of FIG. 58, which allow a user see a comment list corresponding to a comment icon in a text view when the user has clicks on. In some embodiments of the invention, the view internal comments option would allow a user to select to see not only all the comments associated with individual comment icons, but also all the comments associated with a portion of text, such as a few words, a sentence, or a paragraph, and shown in a ranked comment list.

The viewHistory option 554 under the view Menu of FIG. 45 provides a chronological listing of the various views the user has had in the past, recording the nodePath and view settings of each of these successive views. The user is then free to select from this list so as to return to a previous view.

The frames option 555 under the view Menu brings up a window allowing the user to cause his browser to display more than one HTML frame or other type of window and to control the number and arrangement of such separate frames or windows. The use of multiple frames or windows with the views of the present invention would often be very helpful. For example they would allow one to compare two different rankings of statements under a given heading by two different user groups, so as to more easily compare the differences in rankings of such groups, or to compare the differences in votes of such different user groups, or to compare different views of rankings or votes under a given topic or statement by the same user group at different points in time.

FIG. 45's GoTo Menu 488 includes options for changing a users location or view to a different place within the database.

The GoTo menu's parent options 556 enables a user to automatically move to the parent of the current node. The Goto menu's SiblinngUp and SiblingDown options 558 and 559, respectively, enable the user to move up to the preceding sibling of the current node, that is the previous node ranked under the same parent as the current node, and to move to the following sibling node of the current node.

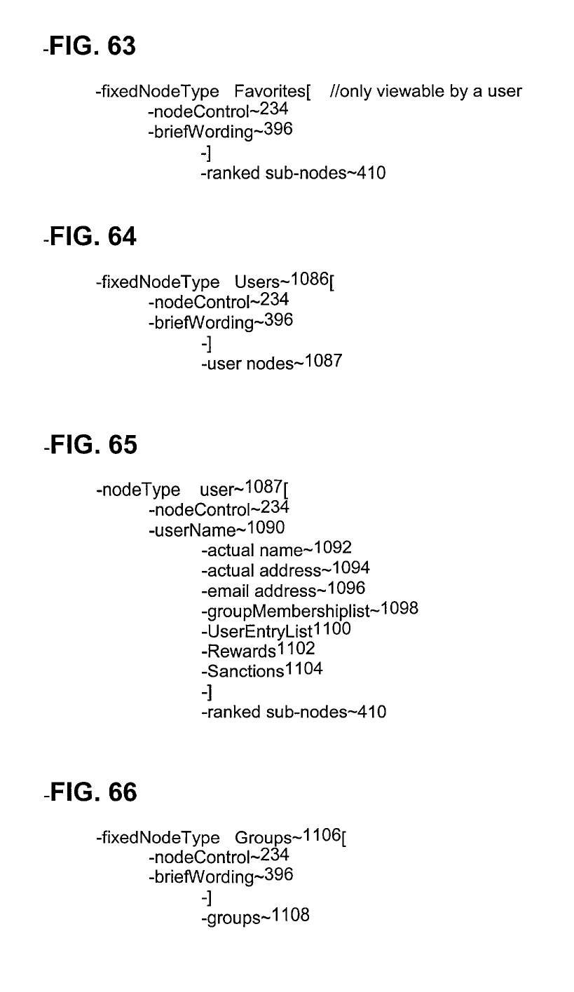

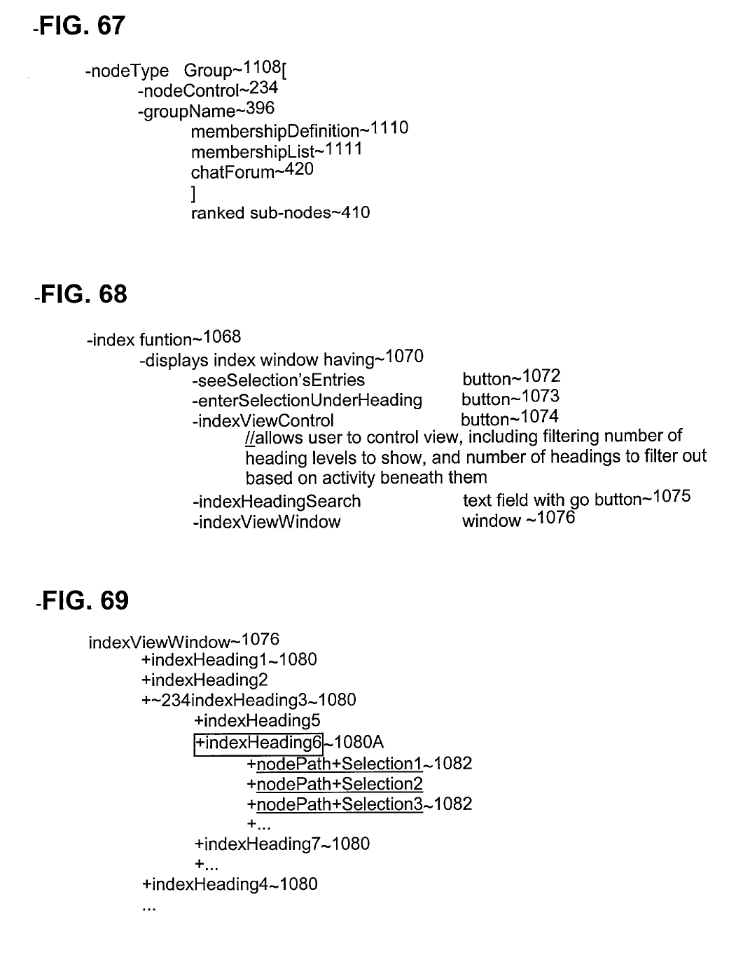

The GoTo menu's options 560 through 578 enable users to move to fixed headings or locations within the database. The Home option 560 enables the user to move to the home node described above with regard to FIG. 28. The Favorites option 562 enables the user to move to a fixed predefined favorites node under which the user can create his own list or hierarchical outline of headings, statements, internal links, URLs to external Web sites, and/or any other type of node supported by the system in a space that is only viewable to the individual user. A description of the fixedNodeType Favorites is shown below with regard to FIG. 63.

The Users option 564 under the GoTo Menu will advance the user to the Users fixedNodeType 1086 shown in FIG. 64.

FIG. 64 shows that the User node is a fixedNodeType under which user nodes 1087 are listed.

FIG. 65 shows that each user node 1087 includes a nodeControl 234, and userName 1090 that functions as the briefWording for the node. The user node includes as predefined sub-nodes an optional actual name 1092, optional actual address 1094, and optional email address 1096 for the user. It also includes a groupMembershipList 1098, which includes a list of all the groups of which the user is a member. It also includes a UserEntryList 1100, which lists all of the user's entries that can be viewed filtered or ordered by date, node, parent node, type of entry, and other criteria. The UserEntry also includes predefined Reward and Sanction sub-nodes 1102 and 1104, respectively.

In different embodiments of the invention, Rewards and Sanctions can be awarded according to different policies. For example Sanctions might be given to people who have been found to make false verifications and Rewards might be given to those who have made verifications that have not been found to be false. Rewards also might be given to those who make entries that have received a high ranking or a high level of activity. Rewards also might be given for those who send email messages including action items that get acted on, and Sanctions may be given to those who send email messages to people who indicate that they were offended by such emails. There are many other possibilities for Rewards and Sanctions, including the giving of monetary Rewards for people who draw new users into the system and who perform functions helpful to the system, such as generating actionList nodes followed by a large number of people.

The GoTo menu's Citations option 570, will advance the user to a list of all citations to given articles, books, Web pages or other sources of information which are contained in the database which can be viewed by source, by date, by author or by other criteria.

Selecting the GoTo menu's Index option 574 will cause the Index steps 1068 shown in FIG. 68 to be executed.

FIG. 68 shows that these include a step 1070, which displays an index window. This window includes a seeSelectionsEntry button 1072, an enterSelectionUnderHeading button 1073, an indexViewControl 1074, an indexHeadingSearch text field and associated go button 1075 and an indexViewWindow 1076.

If the user selects the seeSelection'sEntries button 1072, a window will be generated which shows a rankable lists of all the index heading paths under which the current selection has been placed in the system's index, with each heading path representing the hierarchical path leading to an index heading under which the current selection has been indexed. This list has three separate headings, the first showing all the entries for the exact selection, if any, then a second heading showing all the heading for any sub-selections which occur within the current selection, if any, and then the third heading will show all of the entries for the node in which, or a parent node under which the current selection is located. The seeSelection'sEntries button allows the user to determine how a given node has been indexed and to rank the importance or propriety of such indexing.

The enterSelectionUnderHeading button 1073, if clicked, will display an interface allowing the user to assign a rank for the current selection under an index heading, such as the heading 1080A shown in FIG. 69 which is currently selected within the indexViewWindow 1076 and it will allow the user to rank the node using traditional node ranking techniques.

FIG. 69 shows that when a node or internal selection is pasted under an index heading, a nodePath 1082 for the selection will be placed under the heading that will include an identification of any internal selection that might be associated with the current selection. This nodePath and selection, if any, will be in the form of a link which can be clicked by the user to be taken to its associated selected portion of the database in a view associated not only with the given node and its associated internal selection, if any, but a given nodePath, that is, a given ancestry within the node hierarchy shown in a view.

If the user clicks the indexViewControl button 1074, shown in FIG. 68, she or he will get a ViewControlWindow similar to that described above with regard to FIG. 24, except that it will be customized to control the view within the indexViewWindow. A similar indexViewControlWindow can be generated by clicking on the node control 234 for an index heading, except if the indexViewControlWindow is generated in that way its settings will only apply to the indexheading for which the node Control is clicked and its children.

If the user clicks on the go button 1075 associated with indexHeadingSearch text field of FIG. 68, the selection within the indexViewWindow 1076 shown in FIG. 69 will move to the first top level indexHeading node which contains all, or the longest initial sub-portion of, the text contained in the indexHeadingSearch text field. It is intended that the indexViewWindow be a scrollable window in which a user can scroll among the alphabetically ordered index headings at each level of the indexHeading hierarchy. However, because it is assumed that in a collaborative system there will often be many index entries, it is desirable to be able to search among the top-level index entries using a text entry as is enabled by the indexHeadingSearch text field and go button 1075. It is preferred that the functions provided by the indexViewControlWindow evoked by pressing the button 1074 shown in FIG. 68 will allow the user to not only filter the number of heading levels which can be shown in the outline, by collapsing all node selections in a collapsed subheading directly to locations under the collapsed indexHeading's parent indexHeading, but will also allow the number of indexHeadings and entries shown at any given level to be filtered, such as based on activity.

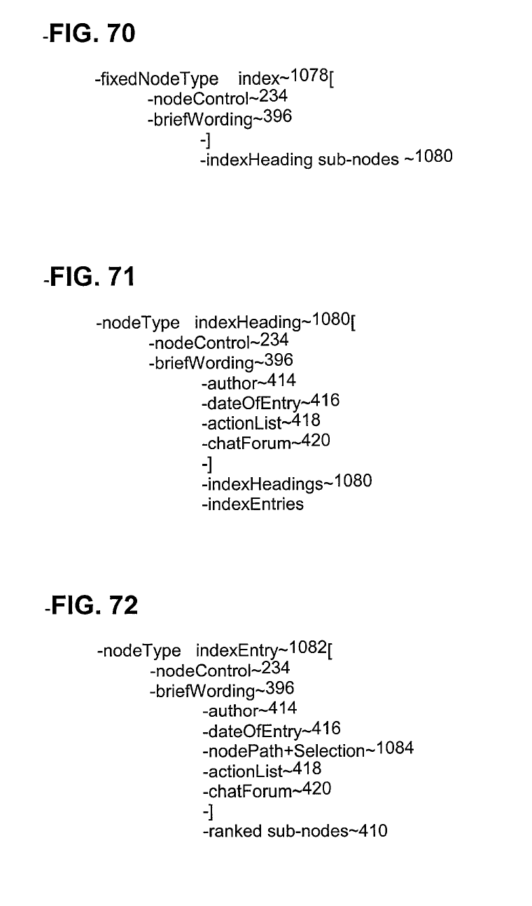

FIG. 70 through 73 illustrate the structure of the index node type 1078, the indexHeading node type 1080, and the indexEntry node type 1082, respectively. These are the node types shown in the indexViewWindow illustrated in FIG. 69. In the fixed index node 1078, the briefWording is merely the word index, and under this node only index sub-Heading nodes can be placed. An indexHeading node 1080 can be placed under the index node 1078 or it can be ranked under another indexHeading. Its briefWording 396, shown in FIG. 71, is defined by the user and normally the indexHeadings under any given parentHeading will be shown ranked alphabetically. Both indexHeadings and indexEntries can be ranked under an indexHeading 1080. The indexEntry node shown in FIG. 72 includes a briefwording 396, which corresponds to text identifying a nodePath+Selection, as in indicated in FIG. 69. This text will identify, and function as a link to, the portion of the database represented by the indexEntry.

In other embodiments, the index need not have more than one level of indexHeadings and indexEntries need not be collaboratively ranked in index, although such changes might prove undesirable.

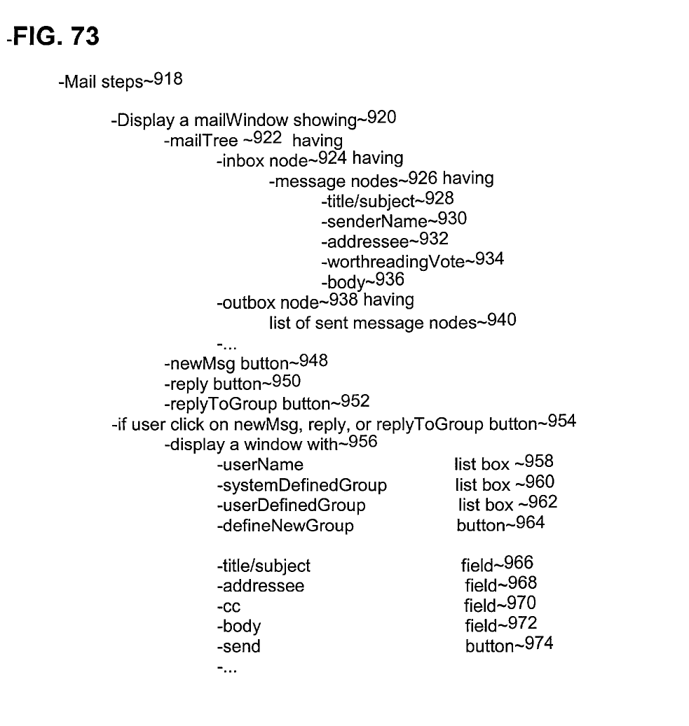

FIG. 45's GoTo menu includes a mail option 576. If this option is selected the steps 918 shown in FIG. 73 will be performed.

FIG. 73 shows that these steps include a step 920, which displays a mailWindow. This mailWindow includes a mailTree 922, a newMsg button 948, a reply button 950, and a replyToGroup button 952, which corresponds somewhat to common functions in many current day mail programs. The mailTree 922 is a hierarchical list, which includes as top-level sub-nodes an inbox node 924 and an sent messages node 938. The inbox node 924 includes a list of received message nodes 926. Preferably, each message node includes as a sub-node a title/subject node 928, a senderName node 930, an addressee node 932, a worthreadingvote 934, and a body 936.

A ViewControlWindow can be evoked for the entire mailTree, for the inbox, or for individual message to control how these nodes are displayed. Commonly the nodes 928 through 934 will be displayed run together on one or more lines so as to enable a larger number of message nodes to be viewed at once, and the body node will normally not be displayed unless the user selects by clicking on a node control to expand it. The viewControlWindow will also allow a user to determine how message nodes are ordered, such as by time and date, by worthreadingvotes given to messages by other recipients of the same message, by subject, by a ranking the user has previously associated with the sender, or by a combination of such factors. It is also hoped that users will use the internal email provided by the system to send each other action items they would like users to act upon. This will help people to mobilize users to help them promote the ranking of, and voting in relation to, nodes within the outline.

The mailTree will include an outbox, or sent message, node 938, which will include a list of sent messages. The messages under this node can be viewed in much the same manner as messages in the inbox.

FIG. 73's newMsg, reply, and replyToGroup buttons 948, 950 and 952, respectively, if clicked, will each cause steps 954 and 956 to display a window for the creation of a new message. This window will include a userName list box 958, a systemDefinedGroup list box 960, a userDefinedGroup list box 962, a defineNewGroup button 964, a title/subject field 966, an addressee field 968, a cc field 970, a body field 972, and a send button 974.

In the embodiment described, the user is not provided with the means to automatically email the users in a given user group, nor are individual email addresses provided for users unless the users specifically want their email address made public. This is done to prevent people from receiving undesired external email. However, other embodiments of the invention might provide a greater capability to use external email to communication with other user groups of individual users of the system.

The controls 958 through 964 are designed to enable a user to select the addressee to be placed within the addressee field 968. If the user selects a userName from the list box 958, that name will be placed in the addressee field. If the user selects a systemDefinedGroup from the list box 960, that group will be placed in the addressee field and the message will be sent to all members of that group. Similarly, if the user selects a userDefinedGroup from the list box 962, that group will be placed in the addressee field. If the user presses the defineNewGroup button 964, the defineNewGroup Window described above with regard to FIG. 26, will be displayed so as to enable a user to define a new group as a Boolean combination of one or more users, previously defined groups, or groups of people who have taken a given action such as a certain ranking or vote with regard to a given node. Once such a new group has been defined in such a defineNewGroup Window, clicking its ok button will cause the members of that group to be treated as the intended recipients in the addressee field 968.

The title/subject field 966 of a message being created identifies the title of the message and corresponds to the field 928 described shown in FIG. 73. The cc field 970 functions exactly like the addressee field and the user can put selected userName, systemDefinedGroups or userDefinedGroups into this field. The body field 972 is an editable field into which the user can edit the text of his message, or can cut and paste it, or its components. The user is free to use the PasteAsLink function to paste in links to desired portions of the database and to action items, internal selections, and verifications which can be sent with messages, such as messages requesting action or participation with regard to such pasted links. If the user clicks the send button 974, the message will be sent via internal email.

It should be understood that external email can also be used with this system since the user can cut and paste portions of a view and include them in external email and can paste as links URLs and actionList items that reference internal locations within the database.

Returning to FIG. 45, if the user selects the GoTo menu's help option 578, a view will be produced of the help section of the database's outline.

FIG. 45's Favorites Menu item 49 includes an addToFavorites option 580, a goToFavorites option 582, a viewsInFavorites option 586 and a locationsOutsideFavorites option 588.

As is stated above, the Favorites portion of the database is a portion in which the user is free to rank and position nodes in any way in which he or she wishes, since no other users will be able to collaboratively rank nodes within that space and since he or she is the only user who is allowed to see what is in it. In some embody of the invention, a user will be allowed to let selected other users access all or a portions of his or her private portion of the database, and groups of users will be able to establish common private portions of the data base which only they can edit and/or see. An example of a chat thread which is limited to viewing by members of a given group is shown in the chatThreadStart node 458A shown in FIG. 56 which can only be viewed by users who have identified themselves as women when establishing their user identity.

If the user selects the addToFavorites option 580, a view of the user's favorite portion of the database will appear and the current selection in the clipboard will be added under to the most recently selected in the Favorites view. The user will then be free at a later time to use node controls or other techniques to rank or position such new nodes within the Favorite hierarchy.

If the user selects the goToFavorites option 586, this is equivalent to the goToFavorites option 562 described above with regard to the GoTo Menu. It will take the user to a top-level view of the Favorites portion of his outline.

If the user clicks the viewsinFavorites option 586, the server will determine at what one or more locations the currently selected node appears under the user's Favorites heading and provides a list of links to those locations, if any.

If the user selects the locationsOutsideFavorites option 588, under the Favorites Menu in FIG. 45, a window will display a list of all the locations, if any, outside of the user's Favorites section, in which the currently selected node in the FavoritesWindow occurs in the database. This list will include links that will enable the user to view the nodes in such various locations.

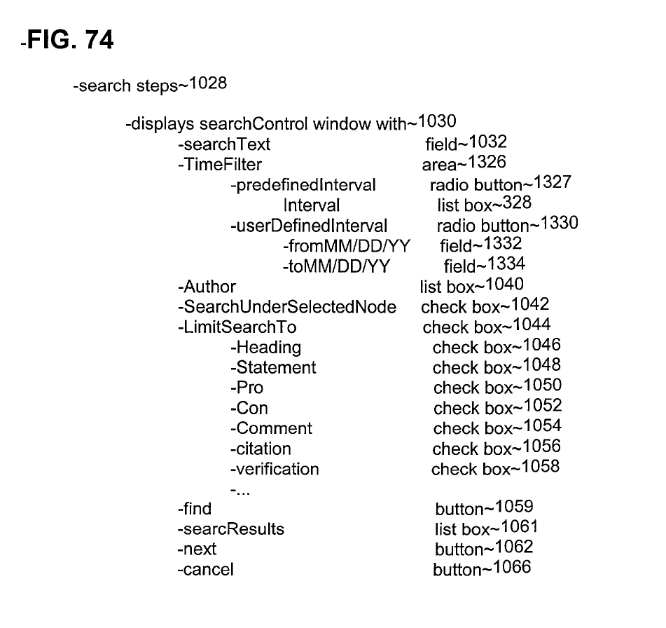

FIG. 45's top-level menu includes a Search Menu item 492. If the user selects this, the search steps 1028 shown in FIG. 74 will be performed.

FIG. 74 shows that these include a step 1030, which display a searchControl window. This window includes a searchText field 1032, into which a user can type Boolean expression with Wild Cards defining what text or combination of text is to be searched for as occurring together within a given node. It is preferred that in other embodiments of the invention this search capability will be supplemented by natural language understanding capabilities.

The searchControl window's TimeFilter area 326 corresponds to the TimeFilter area described above with regard to the ViewControl Window of FIG. 24. This enables the user to limit the search to entries made within a given time period.

The Author list box 1040 allows the user to limit a search to items that have been entered by a given user selected from the Author list box.

The SearchUnderSelectedNode check box 1042 will cause the search to be limited to nodes that are placed or ranked under the currently selected node.

The LimitSearchTo check box 1044 can limit the search to nodes of the type having a corresponding check box 1046 through 1058 checked.

The find button 1059 can cause a search to be performed according to the value of the controls 1032 through 1058 of the SearchControl window, and will cause a list of all nodes or internal selections matching the searchText to be listed in a searchResults list box 1061. The next button 1062 will enable the user to see the node associated with the next item in the SearchResults list box in a separate view window. The cancel button 1066 will remove the Search window from display.

FIG. 45's top-level menu includes a WebPage menu item 494, which includes options relating to using the system of the present invention in conjunction with external Web pages.

If the user selects the WebPage menu's LinksToPage option 590, a window will be generated including a field into which a user can paste the URL of a Web page and then click to see a list of all links occurring in the systems database to that particular URL viewable by date, author, activity, or other criteria.

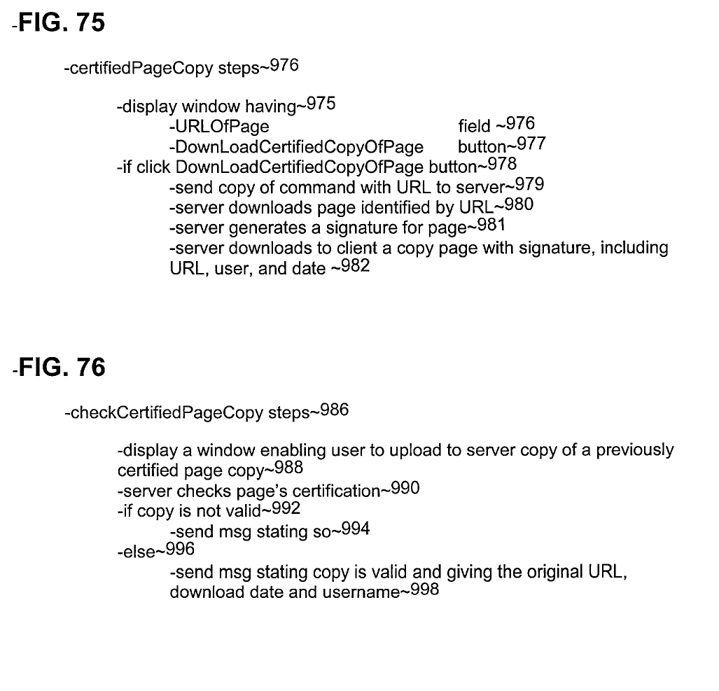

If the user selects the WebPage menu's CertifiedPageCopy item 592, the steps 976 shown in FIG. 75 will be performed to certify a copy of a web page.

FIG. 75 shows that if this happens, step 975 will display a window that includes a URLOfPage text field 976 into which a user can enter or cut and paste the URL of a page whose content he wishes to have certified. This window also includes a DownLoadCertifiedCopyOfPage button 977. If the user clicks on that button, step 978 will cause steps 979 through 982 to be performed. Step 978 sends a copy of the of theDownLoadCertifiedCopyOfPage command with the URL in the field 976 to the server. Then in step 980, the server downloads the page identified by the URL from the Internet to itself. Then in step 981, the server generates a digital signature for the page, which in a simple embodiment could be a check sum or a hash of the digital data contained within the page. In other embodiments, any scheme capable of creating a digital signature can be employed. Then in step 982, the server downloads to the client a copy of the page with the digital signature including the user who requested the page, and the date of the download and signature.

At this point the user will have a certified copy of the Web page which he can then store in his computer as a personal non-commercial copy, which he should be able to show to others for non-commercial purposes, such as verifying that the Web page did or did not contain certain content as of a certain date, without violating any copyright laws.

In some embodiments of the invention, a facility would be provided to allow a user to insert a certified page into the database, with a verification indicating that it has been certified by the system.

Returning to FIG. 45, if the user selects the WebPage menu's CheckCertifiedPageCopy option 594, the steps 986 shown in FIG. 76 will be performed.

FIG. 76 illustrate that these steps include a step 988, which will display a window enabling a user to upload to the server a copy of a web page which has previously been certified by the steps shown in FIG. 75. Once such a page has been uploaded to the server, step 990 causes the server to check the page's certification to ensure that it is authentic. If not, steps 992 and 994 send a message to the user who has requested a certification check, informing him or her that the certification is not valid. If on the other hand, the check of step 990 determines that the page's certification is valid, steps 996 and 998 will send a message to the user informing him or her that the copy of the page is valid and giving the original URL from which it came, the original date on which it was downloaded, and the user name of the user who downloaded it.

The purpose of the checkCertifiedPageCopy function is to enable users who have obtained certified copies using the function shown in FIG. 75 to prove to others that their personal copy of a given Web page is in fact authentic as of its stated date. As stated above with regard to FIG. 75, this can be used for purposes of obtaining verification of statements and citations and for determining whether or not people have made false verifications with regard to statements or citations.

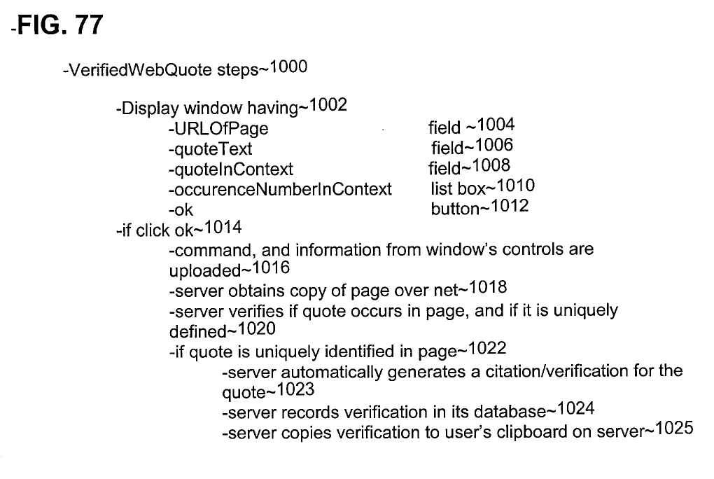

Returning to FIG. 53, if the user selects the WebPage menu's VerifiedWebQuote option 596, the steps 1000 shown in FIG. 77 will be performed.

FIG. 75 illustrates that these steps include a step 1002, which displays a window having a URLOfPage field 1004, a quoteText field 1006, a quotelncontext field 1008, an occurrenceNumberInContext list box 1010, and an ok button 1012. These fields correspond in function to the selectedNodePath text 700, the selectedText field 702, the selectedTextInContext field 704, the occurrenceNumberInContext list box 706, and the ok button 710 described above with regard to the internalSelection function of FIG. 50. The URLOfPage field 1004 is a field into which the user can type or cut and past the URL of a given Web page. The quoteText field is a field into which the user can cut and paste or type a quote from a Web page that he or she wishes to be verified. The quotelnContext field is a field into which the user can paste additional text including the intended quote if it is likely that the quoted text will occur more than one time in the Web page from which it has been copied. The occurrenceNumberInContext list box is used to enable the user to indicate the number of the occurrence of the quoted text within the quotelnContext if it is a quote that is likely to occur more than one time within the quotelnContext.

If the user clicks the ok button 1012, step 1014 will cause steps 1016 through 1026 to be performed. Step 1016 uploads the VerifiedWebQuote command and the information from the controls 1004 through 1010 to the server. Then step 1018 causes the server to download to itself a copy of the Web page identified in the URLOfPage field. Then step 1020 verifies if the quote occurs in the page and is uniquely defined by the information uploaded in a manner similar to that described above with regard to the internalSelection function.

If the quote is uniquely identified in the page, step 1022 will cause steps 1023 through 1025 to be performed. In step 1023 the server automatically generates a citation verification for the Web page quote having a form similar to that described above with regard to FIGS. 52 through 54. Then step 1024 records a digital signature for that verification in the computer's database, so that if the verification is later altered, the system will be able to detect that fact. And then step 1025 causes the server to copy the verification to the user's clipboard on the server so that the user will then be free to insert it into the database as a node or as text contained within a node, or can even send it an internal or external emails to other users.

Returning to FIG. 45, if the user selects the WebPage menu's VerificationFormForPage option 598, a window will be displayed into which the user can cut or paste the URL of a selected page and then the server will automatically generate a verification form for that page having the URL, the common name for the website from which the URL is associated, and the date already filled in and it copies that verification form to the user's clipboard so he can cut and paste it. This verification form is not completely filled out, since it does not specify what is to be verified, but is merely designed to be an expedited form of the createCitation/Verification function described above with regard to FIG. 52.

Referring again to FIG. 45, the top level menu shown in that figure includes a Home Menu option 498 which is equivalent to the Home option 560 shown under the GoTo menu 488. The top-level menu also includes an AboutUs Menu option 500, which takes the user to a page that describes at a high level the overall purpose and function of the system. The top-level menu also includes a Help Menu option 502, which is equivalent to the Help option 578, described above with regard to the GoTo menu item 488.

It should be understood that the foregoing description and drawings are given merely to explain and illustrate the invention and that the invention is not limited thereto, except insofar as the interpretation of the appended claims are so limited. Those skilled in the art who have the disclosure before them will be able to make modifications and variations therein without departing from the scope of the invention.

In particular, it should be noted that this application explains certain aspects of the present invention in more detail than is common in many patent applications, and the inventor trusts he will not be improperly punished for providing a more detailed teaching of his invention to the public by having the scope of his claims limited to that more detailed teaching, since such punishment would be contrary to one of the primary purposes of the patent system, which is to reward inventors for teaching their inventions to the public.

For example, it should be understood that the invention of the present application, as broadly claimed, is not limited to use with any one type of OS, computer hardware, or network protocol.

Although much of the discussion above has been focused on World Wide Web servers, it should be understood that many aspects of the invention are applicable to other types of network servers. It should also be understood that the invention could be used not only on the Internet, but also with other forms of computer networks, including local area networks and wide area networks, as well as host-terminal network systems. In particular, the invention is not limited to use with HTML based systems, but could operate with other types of network protocols, or even proprietary protocols or future network protocols. In fact, many aspects of the invention could be performed on a non-networked computer, with the one computer perform tasks equivalent to both that performed by the client and the server in the examples given above.

It should be understood that the behavior described in the claims below, like virtually all computer behaviors, can be performed by many different programming and data structures, using substantially different organization and sequencing. This is because programming is an extremely flexible art in which a given idea of any complexity, once understood by those skilled in the art, can be manifested in a virtually unlimited number of ways. Thus, the claims are not meant to be limited to the exact steps and sequence of steps described in the figures.

This particularly true since the pseudo-code described in the text above has been highly simplified to enable it to more efficiently communicate that which one skilled in the art needs to know to implement the invention without burdening him or her with unnecessary details. In the interest of such simplification the structure of the pseudo-code described above often differs significantly from the structure of the actual code that a skilled programmer would want to use when implementing the invention.

Furthermore, many of the functions shown being performed in software in the specification could be performed in hardware in other embodiments.

It should be understood that in different embodiments of many aspect of the invention there could be different allocations of functionality between the client and server. For example, in such systems the server could download all or a part of the user interface at one time as an applet or an application, in other embodiments such applets or applications could be sold or distributed as software application on machine readable media, such as CD-ROM. Such applets or applications could perform much of the functionality performed by the server in the pseudo-code above. In other embodiments, the server could generate virtually all the view and windows, including user interface windows, and download them to the client. In other embodiments an intermediate distribution of functionality between the server and client could be used. In fact, it my commonly be the case that the distribute of functionality between the server and different clients in one embodiment of the invention might very as a function of the communication bandwidth and computational power associated with each such client.

In much of the description above the server downloads a user interface in the form of a succession of web pages. In other embodiments of the invention, the client computer could have a plug-in or an application program which would generate its own screen views from information downloaded from the server as wall as information stored on the client. In different embodiments of the invention different amounts of information regarding a session or transaction with a given user or client could be stored with server. For example, as discussed above with regard to FIG. 2, the server could download more of the database to a user than is necessary for the current view, so that the client will normally already have on her or his machine portions of the database that the user is likely to request when expanding a given view. This could be done by sending portions of the database to the client in the form of XML tagged data, which an XML to HTML proxy on the client could convert into HTML pages for the browser. In other embodiments the capability to dynamically generate different views of data downloaded to a client could be performed by programming built into the browser itself.

Those who are knowledgeable about designing computer interfaces, and particularly user interfaces on the World Wide Web, know that there are an unlimited number of ways to design a user interface to perform almost any function. Readers should understand that unless the wording of a claim below are specifically limited to a given user interface feature, the claim should not to be limited to any particular user interface which has been specified above for purposes of example.

For example, it should be understood that the functions shown in the user interfaces described above need not be grouped as they are in the interface above, unless such a grouping is recited in a claim below. In addition, in different embodiments such individual interfaces could include more and/or fewer controls, and/or different types of controls could be used to achieve a given function.

It should be understood that in some embodiments of many aspects of the invention, functions recited as being performed by the server or the client could actually be performed by a plurality of computers. For example, it is now common for large web sites to use a plurality of computers that function together as a web server. Functionality could be distributed across such machines in virtually any desired manner. This is particularly true if the system's database becomes very large, or if it has many users distributed all around the world.

It should be understood that node outlines, of the general type described above, can be projected in different ways in different embodiments of the invention, as well as within a one single embodiment. For example, in some pages containing views of portions of an outline, individual nodes might be shown as occurring other than in the typical indented list of an outline format. For example, in some such pages, nodes of the database might be positioned in a much more free from manner the way links and buttons are commonly distributed in web pages.

Information in the database used with the invention need not all be stored in one server, but could be stored in multiple servers, or even in some embodiments could be stored in a distributed manner in many of the client computers use with the system. In yet other embodiments of certain aspects of the invention, information can be stored on one computer that perform the function of both the server and the client in embodiments described above.

Much of the discussion above of the invention relates to the discussion of political and social issues. It should be understood that it is intended that many of the aspects of the invention can be used as part of many different types of web or other network sites, including those for medical, business, religious, humorous, entertainment, or hobbyist purposes, just to name a few.

It should also be understood that aspect of the invention can be used as subparts of larger web sites. For example, many aspects of the invention can be used as part of a discussion forum in virtually any type of Internet site in which a more intelligent and effective form of organizing and seeing collaborative discussion or input is desired.

It should further be understood that the names given to elements in the embodiments described above are not, in any way, intended to limit the invention to code or interfaces using similar naming.

What I claim is:

1. A computerized method of collaboratively ordering information comprising:
storing a plurality of information nodes;
providing a user interface enabling each of a plurality of users to associate a relative ordinal ranking with each of a set of said nodes under another of said nodes which functions as a parent node;
calculating a group ordinal ranking of each of said set of nodes under said parent node, as a function of the ordinal ranking given to each of said nodes by each of a group of individual users; and
displaying said set of nodes under said parent node ordered as a function of the group ordinal ranking calculated.

2. A computerized method as in claim 1 wherein:
said method further includes providing a user interface enabling a user to select from different groups of users; and
wherein said step of calculating a group ordinal ranking, calculates the ordinal ranking as a function of the selected group based on the ordinal rankings given to nodes by users of the selected group.

3. A computerized method as in claim 1 wherein there are a plurality of said parent nodes under which other nodes are ranked by said method, including some parent nodes under which are ranked other of said parent nodes by said method, so as to create a data structure which can be viewed as a hierarchy.

4. A computerized method as in claim 3 wherein:
said user interface which allows users to associate an ordinal ranking with nodes, enables users to associate a separate ordinal ranking of one node under each of a plurality of said parent nodes; and
said calculating of a group ordinal ranking calculates a separate ranking for a said one node under each of said plurality of parent nodes.

5. A computerized method as in claim 3 further providing a user a hierarchy view expansion interface enabling users to selectively control which parent nodes are to have the nodes ranked under them displayed and which are not to have the parent nodes ranked under them displayed.

6. A computerized method as in claim 5 wherein, when a first set of multiple parent nodes are displayed ranked under a given other parent node, the hierarchy view expansion interface allows a user to select to have nodes ranked under each of said first set of parent nodes be displayed at the same time, so as to create display of nodes which forms a hierarchical tree graph having multiple expanded branches.

7. A computerized method as in claim 5 wherein the hierarchy view expansion interface allows a user to select to have the order in which nodes are displayed under parent nodes be determined by a set of one or more different ordering criteria, in which said group ordinal ranking is only one of the ordering criteria which a user can select to user for the ordering of nodes under a given parent node.

8. A computerized method as in claim 7 wherein said ordering criteria from which a user can select includes at least one from the following set of criteria:
date of nodes creation in outline;
number of a certain type of votes which the node has received,
the amount of a given class of user activity which has been recorded in association with the node, or
the amount of change in a certain criteria associated with the node in a given period of time.

9. A computerized method as in claim 3 wherein:
some of said parent nodes ranked under another parent node are statement nodes which make a statement; and
some of said statement nodes are themselves parent nodes under which other statement nodes are ranked, which other statement node either support or oppose the statement made by their parent statement node.

10. A computerized method of collaboratively ordering information comprising:
storing a plurality of information nodes, at least some of which are link nodes containing links to other media;
providing a user interface enabling each of a plurality of users to associate a selected one of a plurality of values with each of a set of said nodes under another one of said nodes which functions as a parent node;
calculating a group ordinal ranking of each of said set of nodes under said parent node, as a function of the values given to said nodes by each of a group of individual users;
displaying said set of link nodes under said parent node as a function of said calculated ordinal ranking.

11. A computerized method as in claim 10 wherein:
said method further includes providing a user interface enabling a user to select from different groups of users; and
wherein said step of calculating a group ordinal ranking, calculates the ordinal ranking as a function of the selected group based on the values given to nodes by users of the selected group.

12. A computerized method as in claim 10 wherein there are a plurality of said parent nodes under which other nodes are ranked by said method, including some parent nodes under which are ranked other of said parent nodes by said method, so as to create a data structure which can be viewed as a ranked hierarchy.

13. A computerized method as in claim 12 wherein:
some of said link nodes are themselves parent nodes under which other nodes are ranked, which other nodes can include comments about the other media to which the links in their respective parent nodes point.

14. A computerized method of collaboratively ordering information comprising:
storing a plurality of information nodes;
providing a user interface enabling each of a plurality of users to associate a selected one of a plurality of values with each of a set of said nodes under another one of said nodes which functions as a parent node;
calculating a group ordinal ranking of each of said set of nodes under said parent node, as a function of the values given to said nodes by each of a group of individual users;
displaying said set of nodes under said parent node as a function of said calculated ordinal ranking.
Wherein:
there are a plurality of said parent nodes under which other nodes are ranked by said method, including some parent nodes under the which are ranked other of said parent nodes by said method, so as to create a data structure which can be viewed as a hierarchy;
users are provided a hierarchy view expansion interface enabling users to selectively control which parent nodes are to have the nodes ranked under them displayed and which are not to have the parent nodes ranked under them displayed; and
when a first set of multiple parent nodes are displayed ranked under a given other parent node, the hierarchy view expansion interface allows a user to select to have nodes ranked under each of said first set of parent nodes be displayed at the same time, so as to create a display of nodes which forms a hierarchical tree graph having multiple expanded branches.

15. A computerized method as in claim 14 wherein said hierarchy view expansion interface allows a user to selectively control how many of the top ranking nodes under a selected parent node are to be shown in said display.

16. A computerized method as in claim 14 wherein the hierarchy view expansion interface allows a user to select to have the order in which nodes are displayed under parent nodes be determined by a set of one or more different ordering criteria, in which said group ordinal ranking is only one of the ordering criteria which a user can select to use for the ordering of nodes under a given parent node.

17. A computerized method as in claim 16 wherein said ordering criteria from which a user can select includes at least one from the following set of criteria:
date of nodes creation in outline;
number of a certain type of votes which the node has received;
the amount of a given class of user activity which has been recorded in association with the node, or
the amount of change in a certain criteria associated with the node in a given period of time.

18. A computerized method of collaboratively ordering information comprising:
storing a plurality of information nodes;
providing a user interface enabling each of a plurality of users to associate a selected one of a plurality of values with each of a set of said nodes under another one of said nodes which functions as a parent node;
calculating a group ordinal ranking of each of said set of nodes under said parent node, as a function of the values given to said nodes by each of a group of individual users;
displaying said set of link nodes under said parent node as a function of said calculated ordinal ranking;
wherein:
said method further includes providing a user interface enabling a user to select from different groups of users; and
wherein said step of calculating a group ordinal ranking, calculates the ordinal ranking as a function of the selected group based on said values given to nodes by users of the selected group.

19. A computerized method as in claim 18 wherein:
there are a plurality of said parent nodes under which other nodes are ranked by said method, including some parent nodes under which are ranked other of said parent nodes by said method, so as to create a data structure which can be viewed as a hierarchy;
said user interface enabling a user to select from different groups of users, enables a user to select different sets of users for different parent nodes;
said calculating calculates said ordinal rankings under different parent nodes based on the different user groups selected such parent nodes, so that said displaying displays nodes under different parent nodes ranked according to the values selected for such nodes by different groups of users.

20. A computerized method of collaboratively ordering information comprising:
storing a plurality of information nodes;
providing a user interface enabling each of a plurality of users to associate a selected one of a plurality of values with each of a set of said nodes under another one of said nodes which functions as a parent node;
calculating a group ordinal ranking of each of said set of nodes under said parent node, as a function of the values given to said nodes by each of a group of individual users;
displaying said set of link nodes under said parent node as a function of said calculated ordinal ranking;
wherein:
there is a first node hierarchy comprised of a first plurality of said parent nodes under which other of said nodes are ranked by said method, including some parent nodes under which are ranked other of said parent nodes by said method, so as to create a data structure which can be viewed as a hierarchy;
there is second hierarchy of comprised of a second of plurality parent nodes which are index heading nodes, each having an associated text, which index heading nodes are ordered alphabetically in said second hierarchy;
said index heading nodes can have located under them in said second hierarchy:
a set of one or more alphabetically ordered index heading nodes; and/or
a set of one or more link nodes each providing a link to a node in said first hierarchy.

21. A computerized method as in claim 20, further including:
providing a user interface enabling each of a plurality of users to associate a selected one of a plurality of values with each of a set of said link nodes under one of said index heading nodes;
calculating a group ordinal ranking of each of said set of link nodes under said index heading node, as a function of the values given to said nodes by each of a group of individual users;
displaying said set of link nodes under said index heading node as a function of said calculated ordinal ranking.

22. A computerized method of collaboratively ordering information comprising:
storing a plurality of information nodes;
providing a user interface enabling each of a plurality of users to associate a selected one of a plurality of values with each of a set of said nodes under another one of said nodes which functions as a parent node;
calculating a group ordinal ranking of each of said set of nodes under said parent node, as a function of the values given to said nodes by each of a group of individual users;
displaying said set of link nodes under said parent node as a function of said calculated ordinal ranking;
wherein:
said method further includes providing a user interface enabling a user to select a time period which is sub-set of the time during which users have been selecting said values for nodes;
wherein said step of calculating a group ordinal ranking, calculates the ordinal ranking as a function of the rankings given to nodes by said group of user and as a function of the relationship of said rankings to said selected time period.

23. A computerized method as in claim 22 wherein:
there are a plurality of said parent nodes under which other nodes are ranked by said method, including some parent nodes under which are ranked other of said parent nodes by said method, so as to create a data structure which can be viewed as a hierarchy;
said user interface enabling a user to select a time period, enables a user to select different such time periods for different parent nodes;
said calculating calculates the ordinal ranking under each of said different parent nodes as a function of the rankings given to nodes by said group of user and as a function of the relationship of said rankings to the time period selected for each such parent node.

24. A computerized method of collaboratively ordering information comprising:
storing a plurality of information nodes;
providing a user interface enabling each of a plurality of users to associate a selected one of a plurality of values with each of a set of said nodes under another one of said nodes which functions as a parent node;
calculating a group ordinal ranking of each of said set of nodes under said parent node, as a function of the values given to said nodes by each of a group of individual users;
displaying said set of link nodes under said parent node as a function of said calculated ordinal ranking;
wherein:
there are a plurality of said parent nodes under which other nodes are ranked by said method, including some parent nodes under which are ranked other of said parent nodes by said method, so as to create a data structure which can be viewed as a hierarchy; and
some of nodes which are ranked under other parent nodes have ranked in association with them a set of one or more action nodes, each of which action nodes provides a suggestion for collaborative action upon the action node's associated node; and
said method further includes:
providing a user interface enabling each of a plurality of users to associate a selected one of a plurality of values with each of a set of said action nodes;
calculating a group ordinal ranking of each of said set of action nodes as a function of the values given to said nodes by each of a group of individual users;
displaying said set of action nodes in association the associated node ordered as a function of said calculated ordinal ranking.

25. A computerized method as in claim 24 wherein the display of said action nodes include links, which if clicked by a user, cause the method to automatically make the action they suggest.

26. A computerized method as in claim 24 wherein the said method further includes:
automatically track actions taken by a user on a node having a set of associated action nodes; and
automatically selecting said value selected by a user for a given action node as a function of said automatic tracking of actions.

27. A computerized method of collaboratively ordering information comprising:
storing a plurality of information nodes;
providing a user interface enabling each of a plurality of users to associate a selected one of a plurality of values with each of a set of said nodes under another one of said nodes which functions as a parent node;
calculating a group ordinal ranking of each of said set of nodes under said parent node, as a function of the values given to said nodes by each of a group of individual users;
displaying said set of link nodes under said parent node as a function of said calculated ordinal ranking;
providing a search user interface enabling a user to select a pattern and automatically search through said nodes to find a set of one or more nodes having a matching pattern;
displaying said set of matching nodes ordered as a function of their respective values of a certain collaborative activity performed on them by multiple users.

28. A computerized method of collaboratively ordering information comprising:
storing a plurality of information nodes;
providing a user interface enabling each of a plurality of users to associate a selected one of a plurality of values with each of a set of said nodes under another one of said nodes which functions as a parent node;
calculating a group ordinal ranking of each of said set of nodes under said parent node, as a function of the values given to said nodes by each of a group of individual users;
displaying said set of link nodes under said parent node as a function of said calculated ordinal ranking;
providing a user interface for enabling a user to create and edit a message; and
providing a user interface for enabling a user to select, as a groups, the users who have selected to associate a given set of one or more of said values with a given node, and to select to address message to said group.

29. A computerized method of collaboratively ordering information comprising:
storing a plurality of information nodes, at least some of which are chat thread nodes representing a thread in a threaded discussion,
providing a user interface enabling each of a plurality of users to associate a selected one of a plurality of values with each of a set of said nodes under a selected on of a plurality of said nodes which functions as parent nodes, so that different users can rank a given chat thread under different parent nodes;
calculating a group ordinal ranking of each of said nodes, including each of said chat thread nodes, under each parent node it has been ranked, as a function of the values given to said nodes by each of a group of individual users;
displaying said set of nudes, including said chat thread nodes, under the parent node they have been ranked as a function of said calculated ordinal ranking.

30. A computerized method as in claim 29 wherein:
said method further includes providing a user interface enabling a user to select from different groups of users; and
wherein said step of calculating a group ordinal ranking, calculates the ordinal ranking as a function of the selected group based on the values given to nodes by users of the selected group.

31. A computerized method as in claim 29 wherein:
there are a plurality of said parent nodes under which other nodes are also ranked by said method, including some parent nodes under which are ranked other of said parent nodes by said method, so as to create a data structure of parent nodes which can be viewed as a hierarchy; and
said user interface enables different users to rank a given chat thread under different parent nodes in different levels of said hierarchy.

32. A computerized method as in claim 31 further including providing a user interface enabling a user to select a parent node in said hierarchy and to select to have a combined chat thread list displayed in association with the selected parent node which displays chat threads which have been ranked under the selected parent node and any nodes which descend from the selected parent node.

33. A computerized method as in claim 32 further including:
calculating a combined list ordinal ranking for each of said chat thread nodes listed under the selected parent node as a function of the values given to said nodes by each of said group of individual users under the selected parent node and its descendant nodes;
displaying said chat thread nodes in said combined chat thread list as a function of said calculated combined list ordinal ranking.

34. A computerized method of collaboratively ordering information comprising:
storing a plurality of information nodes;
providing a user interface enabling each of a plurality of users to associate a selected one of a plurality of values with each of a set of said nodes under another one of said nodes which functions as a parent node;
calculating a group ordinal ranking of each of said set of nodes under said parent node, as a function of the values given to said nodes by each of a group of individual users;
displaying said set of link nodes under said parent node as a function of said calculated ordinal ranking;
wherein:
there are a plurality of said parent nodes under which other nodes are ranked by said method, including some parent nodes under which are ranked other of said parent nodes by said method, so as to create a data structure which can be viewed as a hierarchy; and further including:
providing a hierarchy view interface enabling users to select a given parent node in said hierarchy and to select to have a combined sub-node list displayed in association with the selected parent node which displays sub-nodes which have been ranked under the selected parent node and sub-nodes which have been ranked under nodes which descend from the selected parent node in said hierarchy,
calculating a combined list ordinal ranking for each of said sub-nodes listed in said combined sub-node list as a function of the values given to said sub-nodes by each of said group of individual users under the selected parent node and its descendant nodes; and
displaying said sub-nodes in said combined sub-node list as a function of said calculated combined list ordinal ranking.

35. A computerized method of collaboratively ordering information comprising:
storing a plurality of information nodes;
providing a user interface enabling each of a plurality of users to associate a selected one of a plurality of values with each of a set of said nodes under another one of said nodes which functions as a parent node;
calculating a group ordinal ranking of each of said set of nodes under said parent node, as a function of the values given to said nodes by each of a group of individual users;
displaying said set of link nodes under said parent node as a function of said calculated ordinal ranking;
wherein:
there are a plurality of said parent nodes under which other nodes are ranked by said method, including some parent nodes under which are ranked other of said parent nodes by said method, so as to create a data structure which can be viewed as a hierarchy; and
users are provided an edit interface enabling each of a plurality of users to selectively edit portions of media contained a selected node and to see edits which have been made to the selected node by other users.

36. A computerized method as in claim 35 further including:
said edit interface enables each of a plurality of users to associate a selected one of a plurality of values with each of a set of edits which have been made to the selected node; and
further including
calculating an edit ordinal ranking for each of said edits made for the selected node as a function of the values given to said edits by each of said group of individual users; and
displaying said edits in a list ordered as a function of said calculated edit ordinal ranking.

37. A computerized method of collaboratively ordering information comprising:
storing a plurality of information nodes on a server computer;
providing a user interface on a client computer enabling each of a plurality of users to associate a selected one of a plurality of values with each of a set of said nodes under another one of said nodes which functions as a parent node;
calculating on a server computer a group ordinal ranking of each of said set of nodes under said parent node, as a function of the values given to said nodes by each of a group of individual users;
displaying on said client computer said set of link nodes under said parent node as a function of said calculated ordinal ranking;
further including:
providing a user interface on a client computer allowing a user to define a quote occurring in media available at an address elsewhere on an internetwork than on said server computer, and an identification of said address;
downloading from said address to said server said media and verifying if said quote occurs in it, and if so generating verification media which identifies that said quote occurred in said media;
providing a user interface on said client computer for enabling said user to insert said verification media into a node which can be stored in a ranked node on said server

38. A computerized method depending from any one of the claims above wherein:
said storing of information nodes and calculation of ordinal rank is done on a server computer; and
said user selections and said user interfaces are provided, and said displaying of said nodes are performed on, a client computer connected to said server computer through a computer network.
